(19) United States
(12) Patent Application Publication
(10) Pub. No.: US 2026/0048594 A1
(43) Pub. Date: Feb. 19, 2026

(54) UV IRRADIATION DEVICE, PRINTING APPARATUS, AND METHOD FOR ADJUSTING UV IRRADIATION DEVICE

(71) Applicant: MIMAKI ENGINEERING CO., LTD., Nagano (JP)

(72) Inventors: Soichiro Takehana, Nagano (JP); Kodai Furukawa, Nagano (JP)

(73) Assignee: MIMAKI ENGINEERING CO., LTD., Nagano (JP)

(21) Appl. No.: 19/102,838

(22) PCT Filed: Aug. 31, 2023
(86) PCT No.: PCT/JP2023/031683

§ 371 Date: Feb. 10, 2025

(30) Foreign Application Priority Data
Sep. 2, 2022 (JP) 2022-140272

(51) Int. Cl. B41J 11/00; B41J 3/407; B41J 29/13; B41M 7/00

(52) U.S. Cl. CPC B41J 11/00212; B41J 3/40731; B41J 3/40733; B41J 11/00214; B41J 11/00218; B41J 29/13; B41M 7/0081

(57) ABSTRACT

Provided are a UV irradiation device and a printing apparatus for easily recognizing what kind of mechanical adjustment is needed. The UV irradiation device includes a rotation mechanism holding a print object and causing the print object to rotate about an axial center of the print object as a rotation center, a UV irradiator configured to irradiate an outer peripheral surface of the print object with ink adhering thereto with UV rays, an input unit used by an operator of the UV irradiation device to input information regarding an outer shape of the print object, and a display unit configured to display mechanical adjustment items of the UV irradiation device. Once the information regarding the outer shape of the print object is input to the input unit, the display unit is able to display the mechanical adjustment items of the UV irradiation device.

### TECHNICAL FIELD

The present invention relates to an Ultraviolet (UV) irradiation device that is used in a printing apparatus for performing printing using a UV curable ink on an outer peripheral surface of a print object having a cylindrical, frustoconical, or conical outer shape. The present invention also relates to a printing apparatus including such a UV irradiation device. Furthermore, the present invention relates to a method for adjusting such a UV irradiation device.

### BACKGROUND ART

Conventionally, a printing apparatus for performing printing by an inkjet method on an outer peripheral surface of a tubular body that does not absorb ink is known (see, for example, Patent Literature 1). The printing apparatus described in Patent Literature 1 includes a cylindrical mandrel to which a tubular body that is a tube made of resin is attached, a motor that causes the mandrel to rotate about an axial center of the mandrel as a rotation center, an inkjet head configured to eject a UV curable ink toward an outer peripheral surface of the tubular body, and a UV irradiation device configured to irradiate the outer peripheral surface of the tubular body with the ink adhering thereto with UV rays. The inkjet head is disposed above the tubular body, and the ink ejected from above the tubular body lands on the outer peripheral surface of the tubular body. The UV irradiation device is disposed below the tubular body.

### CITATION LIST

### Patent Literature

Patent Literature 1: Japanese Unexamined Patent Publication No. 2010-143200

### SUMMARY OF INVENTION

### Technical Problems

The inventor of the present application has developed a UV irradiation device that is used in a printing apparatus for performing printing using a UV curable ink on an outer peripheral surface of a print object with a cylindrical, frustoconical, or a conical outer shape. The UV irradiation device includes a rotation mechanism holding the print object and causing the print object to rotate about an axial center of the print object as a rotation center and a UV irradiator configured to irradiate the outer peripheral surface of the print object with ink adhering thereto with UV rays. In the printing apparatus using the UV irradiation device, an inkjet head is disposed above the print object held by the rotation mechanism, for example, and the ink ejected from above the print object lands on the outer peripheral surface of the print object.

The inventor of the present application has been considering enabling adjustment of an angle of an axial center of a print object held by the rotation mechanism with respect to the horizontal direction in order to enable appropriate printing to be performed on the print object with the distance (gap) between a nozzle surface formed in a lower surface of the inkjet head and the outer peripheral surface of the print object held by the rotation mechanism kept constant in the entire region of the print object in the axis direction even in a case where a print object with a frustoconical or conical outer shape is used, for example, in the UV irradiation device that is being developed.

In other words, the inventor of the present application has been considering enabling adjustment of the angle of the rotation mechanism with respect to the horizontal direction in the UV irradiation device that is being developed. Also, the inventor of the present application has been considering enabling adjustment of the height of the UV irradiator and adjustment of the position of the UV irradiator in the horizontal direction in order to enable the UV irradiator to be disposed at a more appropriate position to cure an ink adhering to the print object even in a case where the print object with a frustoconical or conical outer shape, for example, is used in the UV irradiation device that is being developed.

In this manner, the inventor of the present application has been considering enabling mechanical adjustment of the UV irradiation device in the UV irradiation device that is being developed. In such a UV irradiation device, it is preferable that an operator of the UV irradiation device be able to easily recognize what kind of mechanical adjustment is needed for the UV irradiation device.

Thus, an object of the present invention is to provide a UV irradiation device that is used in a printing apparatus for performing printing using a UV curable ink on an outer peripheral surface of a print object with a cylindrical, frustoconical, or conical outer shape and that enables an operator of the UV irradiation device to easily recognize what kind of mechanical adjustment is needed for the UV irradiation device. Also, an object of the present invention is to provide a printing apparatus including such a UV irradiation device. Furthermore, an object of the present invention is to provide a method for adjusting such a UV irradiation device.

### Solutions to Problems

In order to solve the above problem, a UV irradiation device according to the present invention is a UV irradiation device that is used in a printing apparatus for performing printing using a UV curable ink on an outer peripheral surface of a print object with a cylindrical, frustoconical, or conical outer shape, the UV irradiation device including: a rotation mechanism holding the print object and configured to cause the print object to rotate about an axial center of the print object as a rotation center; a UV irradiator configured to irradiate the outer peripheral surface of the print object with the ink adhering thereto with UV rays; an input unit used by an operator of the UV irradiation device to input an information regarding an outer shape of the print object; and a display unit configured to display mechanical adjustment items of the UV irradiation device, and in which once the information regarding the outer shape of the print object is input to the input unit, the display unit is able to display the adjustment items.

The UV irradiation device according to the present invention includes the input unit used by the operator of the UV irradiation device to input the information regarding the outer shape of the print object and the display unit configured to display the mechanical adjustment items of the UV irradiation device, and once the information regarding the outer shape of the print object is input to the input unit, the display unit can display the mechanical adjustment items of the UV irradiation device. Therefore, according to the present invention, the operator can recognize what kind of mechanical adjustment is needed for the UV irradiation device by the operator visually checking the adjustment items displayed on the display unit. In other words, according to the present invention, the operator can recognize what kind of mechanical adjustment is needed for the UV irradiation device without checking an operation manual for the UV irradiation device. Therefore, according to the present invention, the operator can easily recognize what kind of mechanical adjustment is needed for the UV irradiation device.

In the present invention, it is preferable that the UV irradiation device further includes an input key used by the operator to input a fact that an adjustment of one of the adjustment items has been ended, the number of the adjustment items be more than one, and once the adjustment of the one of the adjustment items is ended and the input key is pressed, the display unit display a next adjustment item. With such a configuration, even if there are a plurality of adjustment items, the operator can easily recognize what kind of mechanical adjustment is needed for the UV irradiation device by the operator visually checking the adjustment item displayed on the display unit every time adjustment of one adjustment item is ended and the operator presses the input key. Also, with such a configuration, it is only necessary for the operator to sequentially perform the mechanical adjustment for the UV irradiation device in accordance with the display on the display unit, and it is thus possible to efficiently and smoothly perform the adjustment of the UV irradiation device even when there are a plurality of adjustment items.

In the present invention, the UV irradiation device further includes, for example, a cover including: a cover portion including an opening formed therein and covering the UV irradiator from an upper side, and an upper end portion of the print object being disposed in the opening; and two second covers for blocking a part of the opening, the ink ejected from above the print object lands on the outer peripheral surface of the print object, the UV irradiator is disposed on a lateral side of the print object and irradiates the outer peripheral surface of the print object with UV rays from the lateral side of the print object, an outer shape of the print object is a frustoconical or conical shape, when a direction perpendicularly intersecting the axial center of the print object in a view from an up-down direction is defined as a left-right direction, the second cover, which is one of the two second covers, is able to block a part of the opening from one side in the left-right direction while the other second cover is able to block a part of the opening from the other side in the left-right direction, an angle of the rotation mechanism with respect to a horizontal direction in a view from the left-right direction, a height of the UV irradiator, a position of the UV irradiator in the left-right direction, an angle of the UV irradiator with respect to the axial center of the print object in a view from the up-down direction, a height of the cover, a position of each of the two second covers in the left-right direction, and angles of the second covers with respect to the axial center of the print object in a view from the up-down direction are able to be adjusted, and the adjustment items include adjustment of the angle of the rotation mechanism with respect to the horizontal direction in a view from the left-right direction, adjustment of the height of the UV irradiator, adjustment of the position of the UV irradiator in the left-right direction and the angle of the UV irradiator with respect to the axial center of the print object in a view from the up-down direction, adjustment of the height of the cover, and adjustment of the positions of the two second covers in the left-right direction and the angles of the second covers with respect to the axial center of the print object in a view from the up-down direction.

In this case, since the angle of the rotation mechanism with respect to the horizontal direction in a view from the left-right direction is adjustable, it is possible to appropriately perform printing on the print object with the distance (gap) between the nozzle surface of the inkjet head and the outer peripheral surface of the print object held by the rotation mechanism kept constant in the entire region of the print object in an axis direction even in a case where the printing apparatus using the UV irradiation device performs printing on a print object with a frustoconical or conical outer shape. In this case, it is possible to adjust the height of the UV irradiator, the position of the UV irradiator in the left-right direction, and the angle of the UV irradiator with respect to the axial center of the print object in a view from the up-down direction and to thereby dispose the UV irradiator at a more appropriate position to cure the ink adhering to the print object.

Furthermore, in this case, it is possible to adjust the height of the cover and to thereby adjust the position of the cover in the up-down direction in accordance with the outer diameter of the print object even in a case where the outer diameter of the print object changes. Also, it is possible to have a gap between an edge of the opening in the cover portion and the print object as a minimum necessary gap by adjusting the position of the cover in the up-down direction in accordance with the outer diameter of the print object. Therefore, it is possible to suppress irradiation of the nozzle surface of the inkjet head with UV rays by the cover portion even in a case where the outer diameter of the print object changes.

In this case, it is possible to adjust the position of each of the two second covers in the left-right direction and the angles of the second covers with respect to the axial center of the print object in a view from the up-down direction and to thereby adjust the positions of the two second covers in the left-right direction and the angles of the second covers with respect to the axial center of the print object in a view from the up-down direction in accordance with the outer diameter and the outer shape of the print object even in a case where the outer diameter and the outer shape of the print object change. Also, it is possible to have a gap between end surfaces of the second covers and the print object as a minimum and necessary gap by adjusting the positions of the two second covers in the left-right direction and the angles of the second covers with respect to the axial center of the print object in a view from the up-down direction in accordance with the outer diameter and the outer shape of the print object. Therefore, it is possible to suppress irradiation of the nozzle surface of the inkjet head with UV rays by the second cover portions even in a case where the outer diameter and the outer shape of the print object change.

In the present invention, it is preferable that the UV irradiation device further includes an adjustment value calculation unit configured to calculate a predetermined adjustment value of the UV irradiation device on the basis of the information regarding the outer shape of the print object input to the input unit, the ink ejected from above the print object land on the outer peripheral surface of the print object, an outer shape of the print object be a frustoconical or conical shape, when a direction perpendicularly intersecting an axial center of the print object in a view from an up-down direction is defined as a left-right direction, an angle of the rotation mechanism with respect to a horizontal direction in a view from the left-right direction be able to be adjusted, and the adjustment items include adjustment of the angle of the rotation mechanism with respect to the horizontal direction in a view from the left-right direction, the adjustment value calculation unit calculate an angle of the rotation mechanism after the adjustment with respect to the horizontal direction in a view from the left-right direction on the basis of the information regarding the outer shape of the print object input to the input unit, and the display unit display the angle of the rotation mechanism after the adjustment calculated by the adjustment value calculation unit. With this configuration, the operator can easily recognize the angle of the rotation mechanism after the adjustment by visually checking the angle of the rotation mechanism after the adjustment displayed on the display unit even if the operator does not calculate the angle of the rotation mechanism after the adjustment. It is thus possible to reduce a burden on the operator.

In the present invention, it is preferable that the UV irradiation device further includes an adjustment value calculation unit configured to calculate a predetermined adjustment value of the UV irradiation device on the basis of the information regarding the outer shape of the print object input to the input unit, the ink ejected from above the print object land on the outer peripheral surface of the print object, the UV irradiator be disposed on a lateral side of the print object and irradiate the outer peripheral surface of the print object with UV rays from the lateral side of the print object, a height of the UV irradiator be adjustable, and the adjustment items include adjustment of a height of the UV irradiator, the adjustment value calculation unit calculate the height of the UV irradiator after the adjustment on the basis of the information regarding the outer shape of the print object input to the input unit, and the display unit display the height of the UV irradiator after the adjustment calculated by the adjustment value calculation unit. With this configuration, the operator can easily recognize the height of the UV irradiator after the adjustment by visually checking the height of the UV irradiator after the adjustment displayed on the display unit even if the operator does not calculate the height of the UV irradiator after the adjustment. It is thus possible to reduce a burden on the operator.

The UV irradiation device according to the present invention can be used in a printing apparatus including a table on which the UV irradiation device is placed and an inkjet head disposed above a print object and configured to eject an ink toward an outer peripheral surface of the print object. According to the printing apparatus, the operator can easily recognize what kind of mechanical adjustment is needed for the UV irradiation device by the operator visually checking the adjustment items displayed on the display unit.

According to a method for adjusting the UV irradiation device of the present invention, an operator adjusts an adjustment item displayed on the display unit, then presses an input key, and then adjusts the next adjustment item displayed on the display unit, for example. In this case, since the adjustment items are sequentially displayed on the display unit, the operator can easily recognize what kind of mechanical adjustment is needed for the UV irradiation device even if there are a plurality of adjustment items. Also, if the UV irradiation device is adjusted by the adjustment method, it is only necessary to sequentially perform the mechanical adjustment for the UV irradiation device in accordance with the display on the display unit, and it is thus possible to efficiently and smoothly perform the adjustment of the UV irradiation device even if there are a plurality of adjustment items.

### EFFECT OF THE INVENTION

As described above, according to the present invention, the operator of the UV irradiation device can easily recognize what kind of mechanical adjustment is needed for the UV irradiation device in a UV irradiation device used in a printing apparatus to perform printing using a UV curable ink on the outer peripheral surface of a print object with a cylindrical, frustoconical, or conical outer shape.

### BRIEF DESCRIPTION OF THE DRAWINGS

FIG. 1 is a front view illustrating a schematic configuration of a printing apparatus according to an embodiment of the present invention.

FIG. 2 is a plan view of a UV irradiation device illustrated in FIG. 1.

FIG. 3 is a front view for explaining a configuration of the UV irradiation device illustrated in FIG. 2.

FIG. 4 is a side view for explaining configurations of a rotation mechanism illustrated in FIG. 3 and a peripheral portion thereof.

FIG. 5 is a side view for explaining the configurations of the rotation mechanism illustrated in FIG. 3 and the peripheral portion thereof.

FIG. 6 are enlarged views for explaining a configuration of a portion E in FIG. 4.

FIG. 7 is a side view for explaining configurations of a UV irradiator illustrated in FIG. and a peripheral portion thereof.

FIG. 8 is a plan view for explaining a state of the UV irradiator and the like when printing is performed on a print object with a frustoconical or conical outer shape illustrated in FIG. 5.

FIG. 9 is a plan view of a cover, second covers, a cover position adjustment mechanism, a third cover, and the like illustrated in FIG. 3.

FIG. 10 is a side view of the cover, the second covers, the cover position adjustment mechanism, the third cover, and the like illustrated in FIG. 9.

FIG. 11 is a front view of the cover, the second covers, the cover position adjustment mechanism, the third cover, and the like illustrated in FIG. 9.

FIG. 12 is a front view illustrating a state where a cover upper portion and a cover lower portion illustrated in FIG. 11 are separated.

In FIG. 13, (A) is an enlarged view for explaining a configuration of a portion F in FIG. 10, and (B) is an enlarged view for explaining a configuration of a portion G in FIG. 10.

FIG. 14 are front views for explaining a disposition relationship of the cover portion and the second cover illustrated in FIG. 9 and a print object.

FIG. 15 is a plan view for explaining the configuration of the portion E in FIG. 4.

FIG. 16 is a block diagram illustrating a configuration for performing mechanical adjustment of the UV irradiation device illustrated in FIG. 3.

FIG. 17 is a process diagram for explaining a procedure for mechanical adjustment of the UV irradiation device illustrated in FIG. 3.

FIG. 18 are side views for explaining a configuration of a peripheral portion of a rotation mechanism according to another embodiment of the present invention.

FIG. 19 is a diagram for explaining the configuration of the peripheral portion of the rotation mechanism from a G-G direction in (A) of FIG. 18.

FIG. 20 is a side view illustrating a support frame, an engagement member, and the like from an H-H direction in FIG. 19.

FIG. 21 are diagrams for explaining a configuration of a J-J section in FIG. 19.

FIG. 22 are diagrams for explaining a configuration of a K-K section in FIG. 19.

FIG. 23 is a side view for explaining a configuration of a peripheral portion of a UV irradiator according to another embodiment of the present invention.

FIG. 24 is a diagram for explaining the configuration of the peripheral portion of the UV irradiator from an M-M direction in FIG. 23.

FIG. 25 is a diagram for explaining a configuration of an N-N section in FIG. 24.

FIG. 26 is a plan view for explaining a configuration of a cover portion according to another embodiment of the present invention.

FIG. 27 is a side view for explaining a configuration of a cover according to another embodiment of the present invention.

FIG. 28 are enlarged side views for explaining a configuration of a third cover according to another embodiment of the present invention.

FIG. 29 is a front view for explaining a configuration of a UV irradiation device according to another embodiment of the present invention.

FIG. 30 is a bottom view illustrating a configuration of a part of the UV irradiation device from a P-P direction in FIG. 29.

FIG. 31 is a plan view for explaining a configuration of a rotation mechanism according to another embodiment of the present invention.

FIG. 32 is a sectional view of a Q-Q section in FIG. 31.

FIG. 33 is an enlarged plan view for explaining a configuration of a portion R in FIG. 31.

FIG. 34 is an enlarged plan view for explaining the configuration of the portion R in FIG. 31.

### DESCRIPTION OF EMBODIMENTS

Hereinafter, embodiments of the present invention will be described with reference to the drawings.

### Schematic Configuration of Printing Apparatus

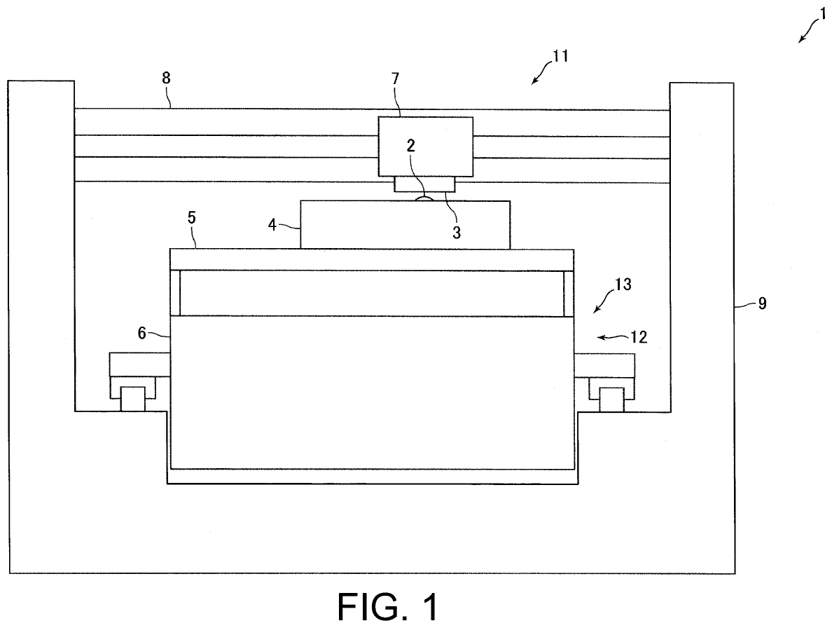

FIG. 1 is a front view illustrating a schematic configuration of a printing apparatus 1 according to an embodiment of the present invention.

A printing apparatus 1 according to the embodiment is a device for performing printing using a UV curable ink on an outer peripheral surface of a print object 2 with a cylindrical, a frustoconical, or a conical outer shape and is, for example, an inkjet printer for professional use. The print object 2 is formed into a tubular shape, for example. In other words, the print object 2 is formed into a cylindrical, frustoconical, or a conical shape. Also, the print object 2 is formed of a resin, for example. The printing apparatus 1 can perform printing on a plurality of types of print objects 2 with different outer diameters and lengths. For example, the outer diameters of the print objects 2 on which the printing apparatus 1 can perform printing range from 40 (mm) to 110 (mm).

The printing apparatus 1 includes an inkjet head 3 that ejects a UV curable ink toward an outer peripheral surface of each print object 2, a UV irradiation device 4 that is for curing the ink ejected to the outer peripheral surface of the print object 2, a stage 6 having a table 5 on which the UV irradiation device 4 is placed, a carriage 7 on which the inkjet head 3 is mounted, a Y bar 8 holding the carriage 7 to enable movement in a main scanning direction, and a main body frame 9 holding the stage 6 to enable movement in a sub-scanning direction perpendicularly intersecting an up-down direction (vertical direction) and the main scanning direction.

The printing apparatus 1 includes a carriage driving mechanism 11 that causes the carriage 7 to move in the main scanning direction with respect to the Y bar 8, a stage driving mechanism 12 that causes the stage 6 to move in the sub-scanning direction with respect to the main body frame 9, and a table lifting and lowering mechanism 13 that lifts and lowers the table 5. The carriage driving mechanism 11 includes, for example, a motor and a power transmission mechanism, such as a belt and a pulley, that transmits power of the motor to the carriage 7. The stage driving mechanism 12 includes, for example, a motor and a power transmission mechanism, such as a belt and a pulley, that transmits power of the motor to the stage 6. The table lifting and lowering mechanism 13 includes, for example, a motor and a power transmission mechanism, such as a ball spring, that transmits power of the motor to the table 5.

An upper surface of the table 5 is a plane perpendicularly intersecting the up-down direction. The UV irradiation device 4 placed on the table 5 is disposed further downward than the inkjet head 3. The print object 2 is held by the UV irradiation device 4 and is disposed below the inkjet head 3. In other words, the inkjet head 3 is disposed above the print object 2. The inkjet head 3 ejects an ink downward.

The ink ejected by the inkjet head 3 lands on the outer peripheral surface of the print object 2 at an upper end portion of the print object 2. In other words, the ink ejected from above the print object 2 lands on the outer peripheral surface of the print object 2. A lower surface of the inkjet head 3 serves as a nozzle surface on which a plurality of nozzles for ejecting the ink are arranged. The distance (gap) between the nozzle surface of the inkjet head 3 and the upper end of the print object 2 is, for example, 2 (mm).

### Overall Configuration of UV Irradiation Device

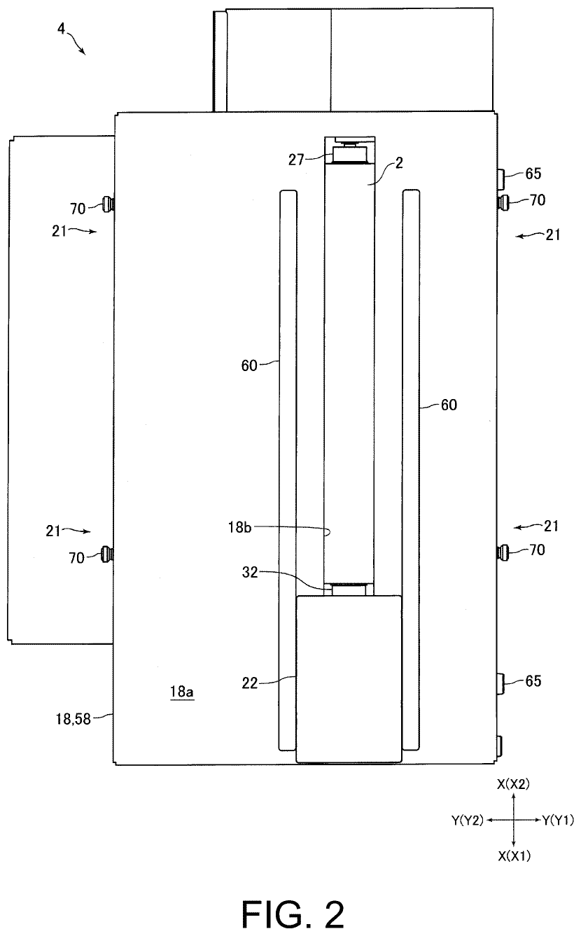

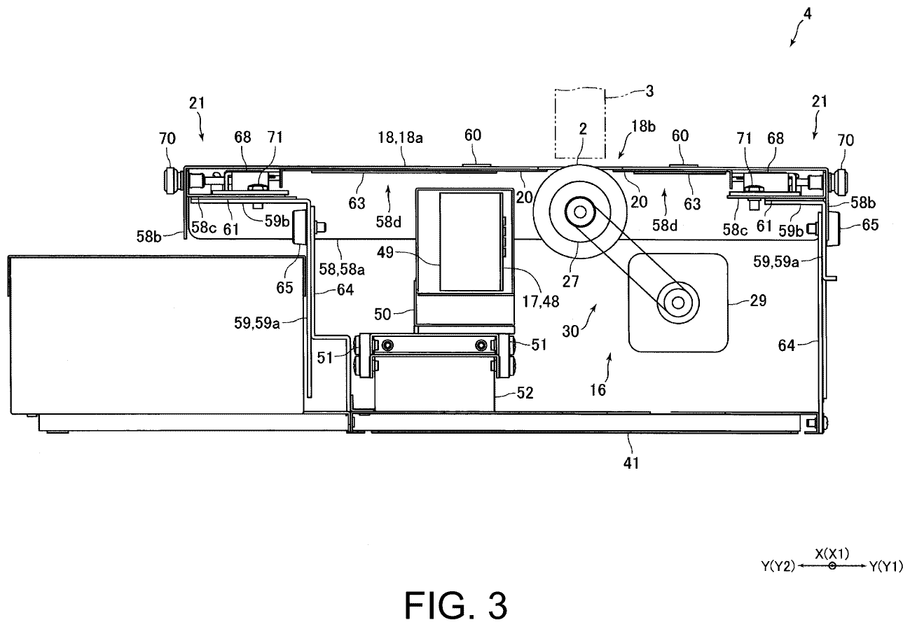

FIG. 2 is a plan view of the UV irradiation device 4 illustrated in FIG. 1. FIG. 3 is a front view for explaining a configuration of the UV irradiation device 4 illustrated in FIG. 2.

The UV irradiation device 4 includes a rotation mechanism 16 that holds the print object 2 and causes the print object 2 to rotate about the axial center of the print object 2 as a rotation center. In the present embodiment, the direction of the axial center of the print object 2 is parallel to the horizontal direction when printing is performed on the print object 2 with a cylindrical outer shape. On the other hand, the direction of the axial center of the print object 2 is inclined with respect to the horizontal direction when printing is performed on the print object 2 with a frustoconical or conical outer shape. At this time, the inclination angle of the direction of the axial center of the print object 2 with respect to the horizontal direction is not that large and is, for example, about 15° at maximum.

In the following description, the direction of an axial center of the print object 2 in a view from the up-down direction (the X direction in FIG. 2 and the like) is defined as a front-rear direction, and the direction perpendicularly intersecting the axial center of the print object 2 in a view from the up-down direction (the Y direction in FIG. 2 and the like) is defined as a left-right direction. In other words, the horizontal direction which is also the direction of the axial center of the print object 2 in a view from the up-down direction is defined as the front-rear direction, and the horizontal direction which is also the direction perpendicularly intersecting the axial center of the print object 2 in a view from the up-down direction is defined as the left-right direction. In the following description, the side of the X1 direction in FIG. 2 and the like which is one side in the front-rear direction is defined as a “front” side, the side of the X2 direction in FIG. 2 and the like that is opposite to the side of the X1 direction is defined as a “rear” side, the side of the Y1 direction in FIG. 2 and the like which is one side in the left-right direction is defined as a “right” side, and the side of the Y2 direction in FIG. 2 and the like that is opposite to the side of the Y1 direction is defined as a “left”side.

In the present embodiment, the UV irradiation device 4 is placed on the table 5 such that the left-right direction and the main scanning direction coincide with each other (that is, such that the front-rear direction and the sub-scanning direction coincide with each other). Note that in the present embodiment, printing is performed on the print object 2 while the print object 2 is caused to rotate by the rotation mechanism 16 in a state where the inkjet head 3 is stopped at a specific position. In the present embodiment, the length (the length in the direction of the axial center) of the print object 2 is longer than the width of the inkjet head 3 in the front-rear direction, and the table 5 is thus caused to move in the front-rear direction (sub-canning direction) in a stepwise manner when printing is performed on the print object 2.

The UV irradiation device 4 includes a UV irradiator 17 that irradiates the outer peripheral surface of the print object 2 with an ink adhering thereto with UV rays and a cover 18 including a cover portion 18a that covers the UV irradiator 17 from the upper side. The cover portion 18a has an opening 18b in which the upper end portion of the print object 2 is disposed. The UV irradiator 17 is disposed on a lateral side of the print object 2. Specifically, the UV irradiator 17 is disposed on the left side of the print object 2. The UV irradiator 17 irradiates the print object 2 with UV rays from the lateral side of the print object 2. In other words, the UV irradiator 17 irradiates the print object 2 with UV rays from the left side of the print object 2.

In the present embodiment, the rotation mechanism 16 causes the print object 2 to rotate in the counterclockwise direction in a view from the front side when printing is performed on the print object 2. Also, the UV irradiator 17 is disposed on the left side of the print object 2 as described above. In other words, the UV irradiator 17 is disposed on the lateral side of the print object 2 and is disposed on the side downstream a point at which the ink lands on the outer peripheral surface of the print object 2 in the direction of rotation of the print object 2 achieved by the rotation mechanism 16. Also, the UV irradiator 17 irradiates the print object 2 with UV rays from the left side of the print object 2. Therefore, the part of the outer peripheral surface of the print object 2 at which the ink has landed is irradiated with UV rays after the ink lands on the print object 2 at the upper end portion of the print object 2 and before the print object 2 rotates by 180°.

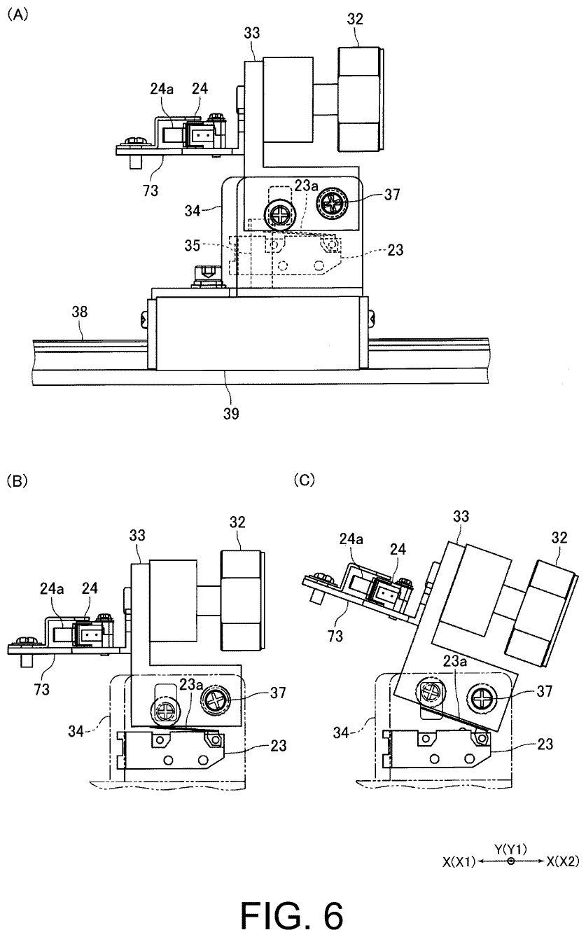

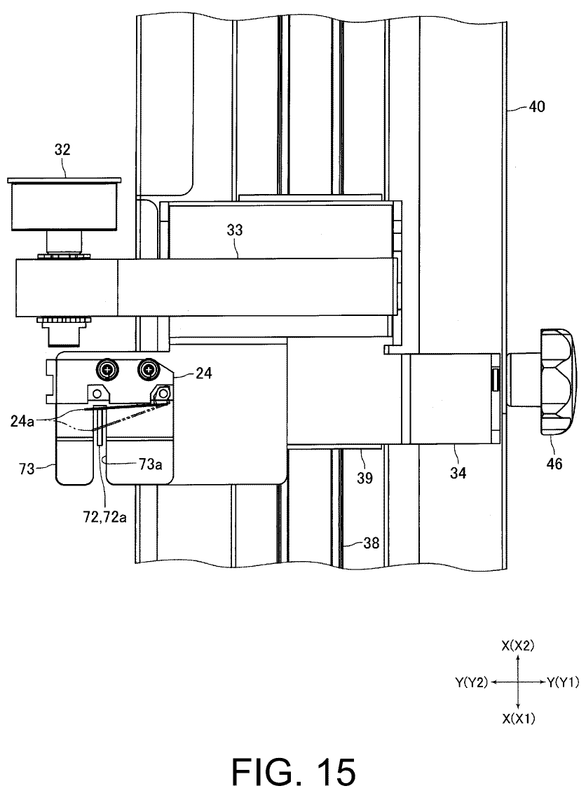

The UV irradiation device 4 includes two second covers 20 for blocking a part of the opening 18b from the outer sides in the left-right direction and cover position adjustment mechanisms 21 for adjusting the positions of the two second covers 20 in the left-right direction. In other words, the position of each of the two second covers 20 in the left-right direction is adjustable. The UV irradiation device 4 according to the present embodiment includes four cover position adjustment mechanisms 21. Furthermore, the UV irradiation device 4 includes a third cover 22 that blocks a part of the opening 18b in the front-rear direction. The third cover 22 is placed on the cover portion 18a. Also, the UV irradiation device 4 includes a first detection mechanism 23 (see FIG. 6) for detecting that the print object 2 is being held by the rotation mechanism 16 and a second detection mechanism 24 (see FIG. 15 and the like) for detecting that the third cover 22 is being placed on the cover portion 18a. Note that illustration of the third cover 22 is omitted in FIG. 3.

### Configurations of Rotation Mechanism and Peripheral Portion of Rotation Mechanism

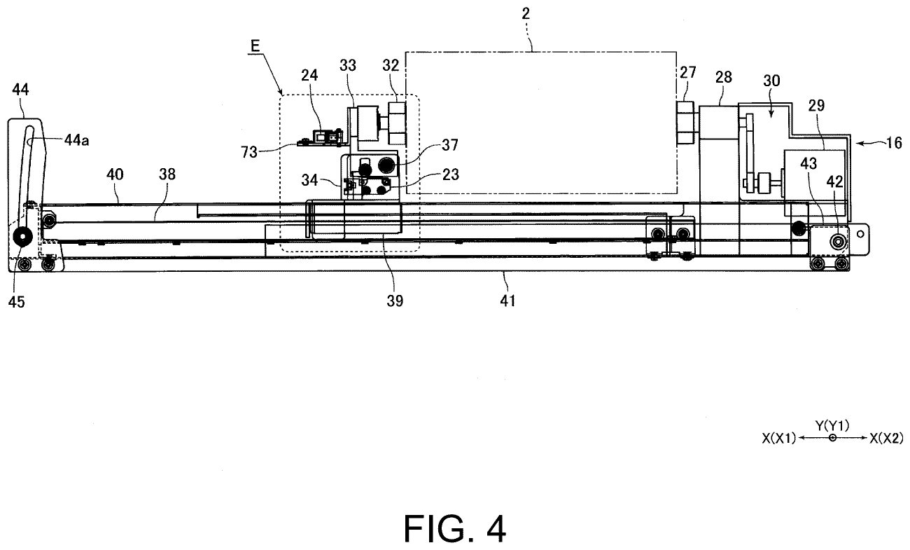

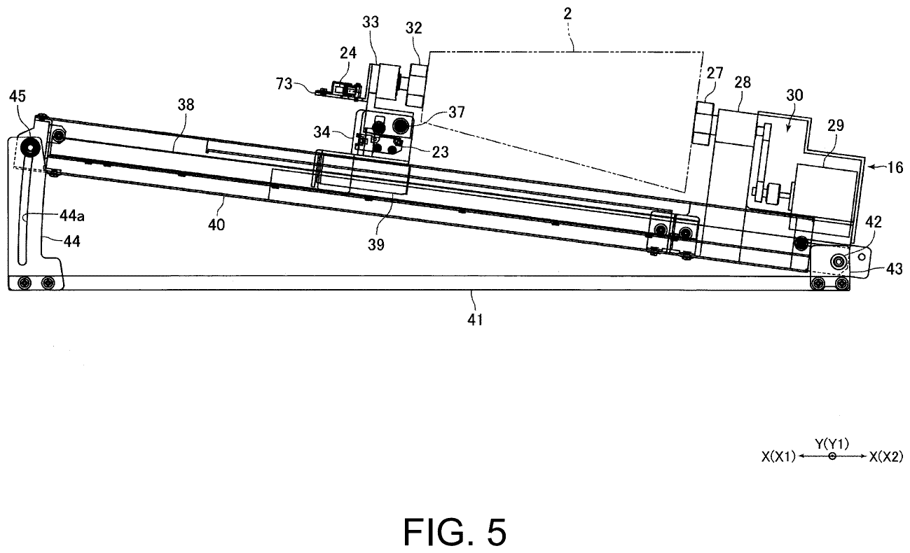

FIGS. 4 and 5 are side views for explaining configurations of the rotation mechanism 16 illustrated in FIG. 3 and the peripheral portion thereof. FIG. 6 are enlarged views for explaining a configuration of a portion E in FIG. 4.

The rotation mechanism 16 includes a first rotating portion 27 that holds one end of the print object 2, a first holding portion 28 that rotatably holds the first rotating portion 27, a motor 29 that causes the first rotating portion 27 to rotate, a power transmission mechanism 30 that couples the first rotating portion 27 to the motor 29, a second rotating portion 32 that holds the other end of the print object 2, a second holding portion 33 that rotatably holds the second rotating portion 32, a third holding portion 34 that turnably holds the second holding portion 33 to enable rotation of the second holding portion 33 about the left-right direction as a rotation axis direction, and a compression coil spring 35 (see (A) of FIG. 6) that biases the second holding portion 33 with respect to the third holding portion 34 in a direction in which the second holding portion 33 is inclined on the side of the first holding portion 28.

The first rotating portion 27 and the second rotating portion 32 rotate together with the print object 2. The first rotating portion 27 holds a rear end of the print object 2, and the second rotating portion 32 holds a front end of the print object 2. The first rotating portion 27, the first holding portion 28, the motor 29, and the power transmission mechanism 30 are disposed behind the print object 2. The second rotating portion 32, the second holding portion 33, the third holding portion 34, and the compression coil spring 35 are disposed in front of the print object 2. The power transmission mechanism 30 is configured of a belt and a pulley. Note that the power transmission mechanism 30 may be configured of a gear train.

The second holding portion 33 is turnably coupled to an upper end portion of the third holding portion 34. The second holding portion 33 is turnable with respect to the third holding portion 34 with a turning center shaft 37, which is disposed on the rear end side of the upper end portion of the third holding portion 34, located at the center. The compression coil spring 35 is disposed on the side further forward than the turning center shaft 37. The compression coil spring 35 is in contact with second holding portion 33 from below, and biases second holding portion 33 upward. In other words, the second holding portion 33 is biased in the clockwise direction in FIG. 6 around the turning center shaft 37 at the center by the compression coil spring 35.

When the print object 2 is not attached to the rotation mechanism 16, the second holding portion 33 is inclined on the side of the first holding portion 28 with a biasing force of the compression coil spring 35 (see (C) of FIG. 6). In other words, when the print object 2 is not attached to the rotation mechanism 16, the axial center of the second rotating portion 32 is inclined with respect to the axial center of the first rotating portion 27. Once the print object 2 is attached to the rotation mechanism 16, the second holding portion 33 is turned to a position where the axial center of the second rotating portion 32 and the axial center of the print object 2 coincide with each other against the biasing force of the compression coil spring 35.

The third holding portion 34 is movable in the direction of the axial center of the print object 2 to thereby enable adjustment of the position of the third holding portion 34 in the direction of the axial center of the print object 2. In the present embodiment, the positions of the second rotating portion 32, the second holding portion 33, and the third holding portion 34 in the direction of the axial center of the print object 2 are adjusted in accordance with the length of the print object 2. Also, the inclination of the rotation mechanism 16 with respect to the horizontal direction in a view from the left-right direction is adjustable in the present embodiment. In other words, the inclination of the axial center of the print object 2 with respect to the horizontal direction is adjustable. In the present embodiment, the inclination of the rotation mechanism 16 is adjusted when printing is performed on the outer peripheral surface of the print object 2 with a frustoconical or conical outer shape as illustrated in FIG. 5.

The rotation mechanism 16 includes a guide rail 38 that guides the third holding portion 34 in the direction of the axial center of the print object 2, a guide block 39 that is engaged with the guide rail 38 and has the third holding portion 34 fixed thereto, and a turning frame 40 to which the guide rail 38 is fixed. The turning frame 40 is formed into an elongated shape that is thin and long in the direction of the axial center of the print object 2. A lower end portion of the first holding portion 28 is fixed to the turning frame 40. In other words, the first rotating portion 27 is rotatably attached to the turning frame 40 via the first holding portion 28.

The guide block 39 is engaged with the guide rail 38 from the upper side. The guide block 39 is disposed on the side further downward than the second holding portion 33. The third holding portion 34 is fixed to the guide block 39. In other words, the second rotating portion 32 is rotatably attached to the turning frame 40 via the second holding portion 33, the third holding portion 34, the guide block 39, and the guide rail 38. The guide block 39 moves in the direction of the axial center of the print object 2 together with the third holding portion 34.

A screw insertion hole (not illustrated) that is thin and long in the direction of the axial center of the print object 2 is formed in the turning frame 40. A fixing screw 46 (see FIG. 15) for fixing the third holding portion 34 to the turning frame 40 is inserted into the screw insertion hole. A screw hole with which the fixing screw 46 is engaged is formed in the third holding portion 34. Once the fixing screw 46 is loosened, it is possible to cause the second rotating portion 32, the second holding portion 33, and the third holding portion 34 to move in the direction of the axial center of the print object 2 along the guide rail 38.

The turning frame 40 is turnable with respect to a lower frame 41 configuring a bottom surface of the UV irradiation device 4. Specifically, the turning frame 40 is turnable with respect to the lower frame 41 with the left-right direction defined as a turning axis direction. Also, the turning frame 40 is turnable around the turning center shaft 42, which is disposed on the rear end side of the UV irradiation device 4, located at the center. Support frames 43 are fixed to a rear end portion of the lower frame 41. The turning center shaft 42 is attached to the support frames 43. The support frames 43 are disposed at two locations in a state where a clearance is left therebetween in the left-right direction. Specifically, the support frames 43 are disposed on both end sides of the turning frame 40 in the left-right direction.

Guide frames 44 are fixed to a front end portion of the lower frame 41. Guide holes 44a to guide the turning frame 40 in the turning direction of the turning frame 40 are formed in the guide frames 44. The guide holes 44a penetrate through the guide frames 44 in the left-right direction. The shape of the guide holes 44a in a view from the left-right direction is an arc shape including the turning center shaft 42 as a turning center. The guide frames 44 are disposed at two locations in a state where a clearance is left therebetween in the left-right direction. Specifically, the guide frames 44 are disposed on both end sides of the turning frame 40 in the left-right direction.

Fixing screws 45 to fix a front end portion of the turning frame 40 to the guide frame 44 are inserted into the guide holes 44a. The fixing screws 45 are thumbscrews. Screw holes with which the fixing screws 45 are engaged are formed at the front end portion of the turning frame 40. Once the fixing screws 45 are loosened, it is possible to cause the turning frame 40 to turn with respect to the lower frame 41, the support frames 43, and the guide frames 44 with the turning center shaft 42 located at the center. Furthermore, the inclination of the rotation mechanism 16 with respect to the horizontal direction is adjusted by causing the turning frame 40 to turn.

In the present embodiment, the turning frame 40 is fixed such that the direction of the axial center of the print object 2 and the front-rear direction coincide with each other as illustrated in FIG. 4 when printing is performed on the print object 2 with a cylindrical outer shape. In other words, the axial center of the print object 2 is disposed on the horizontal plane when printing is performed on the print object 2 with a cylindrical outer shape. Also, the inclination of the rotation mechanism 16 is adjusted, and the turning frame 40 is fixed, such that the upper end of the print object 2 is parallel to the front-rear direction as illustrated in FIG. 5 when printing is performed on the print object 2 with a frustoconical or conical outer shape.

### Configurations of UV Irradiator and Peripheral Portion of UV Irradiator

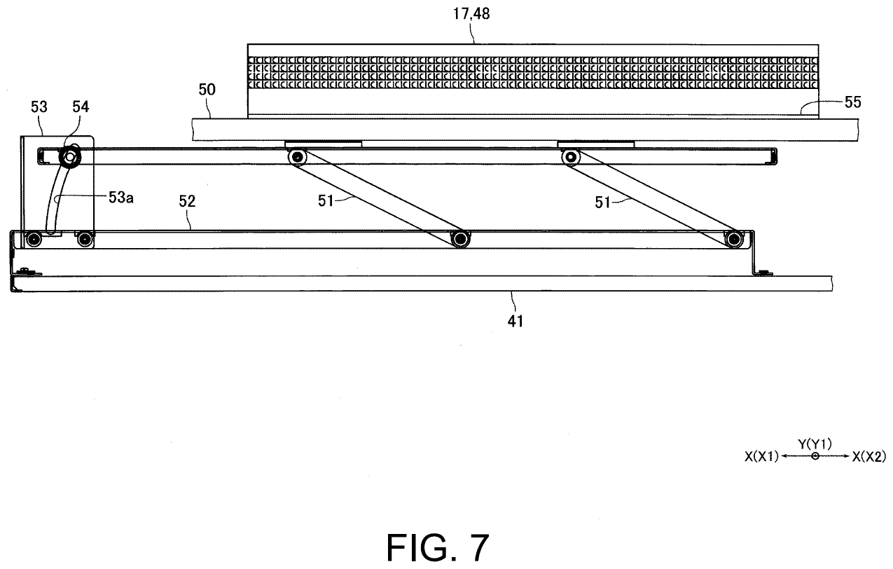

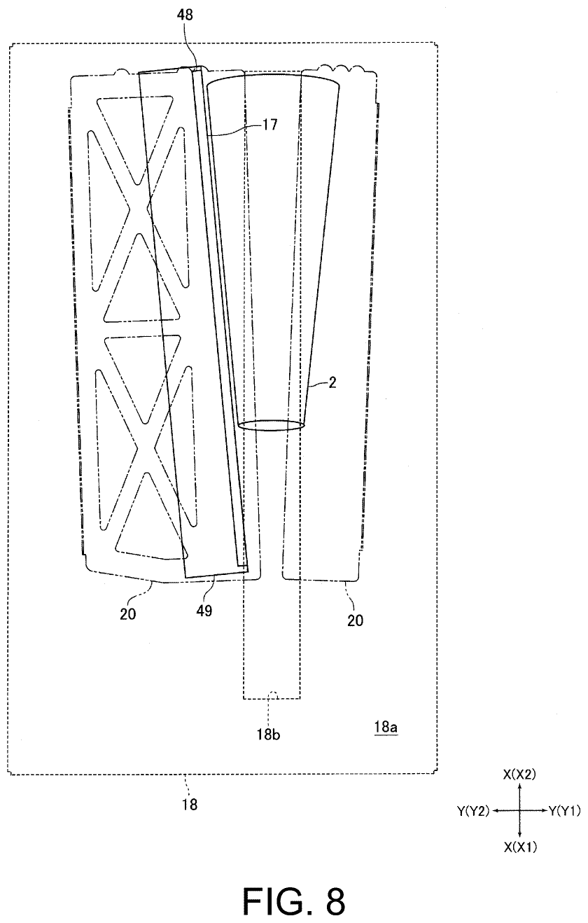

FIG. 7 is a side view for explaining the configurations of the UV irradiator 17 illustrated in FIG. 3 and a peripheral portion thereof. FIG. 8 is a plan view for explaining a state of the UV irradiator 17 and the like when printing is performed on the print object 2 with a frustoconical or conical outer shape illustrated in FIG. 5.

The UV irradiator 17 includes an LED substrate 48 on which a large number of LED chips that emits UV rays (UV light) are mounted. The LED substrate 48 is formed into a rectangular flat plate shape that is thin and long. The LED substrate 48 is disposed such that the short side direction of the LED substrate 48 formed in the rectangular shape coincides with the up-down direction in a view from the left-right direction and the long side direction of the LED substrate 48 coincides with the front-rear direction. As described above, the UV irradiator 17 is disposed on the left side of the print object 2. The UV irradiator 17 emits UV rays toward the right side. In the present embodiment, the position of the UV irradiator 17 in the up-down direction is adjustable. Also, the position of the UV irradiator 17 in the left-right direction and the inclination of the UV irradiator 17 with respect to the axial center of the print object 2 in a view from the up-down direction are adjustable.

The UV irradiator 17 is fixed to a holding portion 49. The holding portion 49 to which the UV irradiator 17 is attached is placed on a placement portion 50. An upper surface of the placement portion 50 is a plane that perpendicularly intersects the up-down direction. End portions of a pair of mutually parallel link members 51 on one side are turnably coupled to the placement portion 50. The other end portions of the link members 51 are turnably coupled to a holding frame 52 fixed to the lower frame 41. The holding frame 52 is disposed on the side further downward than the placement portion 50.

The link members 51 are turnable with respect to the placement portion 50 and the holding frame 52 with the left-right direction defined as a turning axis direction. The pair of link members 51 are disposed at two locations in a state where a clearance is left therebetween in the left-right direction. Specifically, the pair of link members 51 are disposed on both end sides of the placement portion 50 and the holding frame 52 in the left-right direction as illustrated in FIG. 3. In the present embodiment, a parallel link mechanism is formed by the placement portion 50, the link member 51, and the holding frame 52.

Guide frames 53 are fixed to a front end portion of the holding frame 52. Guide holes 53a to guide the placement portion 50 in the up-down direction are formed in the guide frames 53. The guide holes 53a penetrate through the guide frames 53 in the left-right direction. The guide holes 53a are formed in an arc shape. The guide frames 53 are disposed at two locations in a state where a clearance is left therebetween in the left-right direction. Specifically, the guide frames 53 are disposed on both end sides of the placement portion 50 and the holding frame 52 in the left-right direction.

Fixing screws 54 to fix a front end portion of the placement portion 50 to the guide frames 53 are inserted into the guide holes 53a. The fixing screws 54 are thumbscrews. Screw holes with which the fixing screws 54 are engaged are formed at the front end portion of the placement portion 50. Once the fixing screws 54 are loosened, it is possible to cause the placement portion 50 to be lifted and lowered with respect to the lower frame 41, the holding frame 52, and the guide frames 53. The position of the UV irradiator 17 in the up-down direction is adjusted by lifting or lowering the placement portion 50. In the present embodiment, the position of the UV irradiator 17 in the up-down direction is adjusted in accordance with the outer shape of the print object 2 such that an optimal location of the outer peripheral surface of the print object 2 is irradiated with UV rays.

A magnet sheet 55 which is a sheet-shaped permanent magnet is attached to a lower surface of the holding portion 49. The member configuring the upper surface of the placement portion 50 is a magnetic member made of a metal material with magnetism. The holding portion 49 is fixed to the upper surface of the placement portion 50 with a magnetic adsorption force caused between the magnet sheet 55 and the upper surface of the placement portion 50. In the present embodiment, the position of the UV irradiator 17 in the left-right direction is adjusted by causing the holding portion 49 fixed to the upper surface of the placement portion 50 with a magnetic adsorption force to move in the left-right direction. Furthermore, the inclination of the UV irradiator 17 with respect to the axial center of the print object 2 in a view from the up-down direction is adjusted by inclining the holding portion 49 fixed to the upper surface of the placement portion 50 within the horizontal plane with a magnetic adsorption force.

In the present embodiment, the UV irradiator 17 is installed such that a UV ray emission surface of the UV irradiator 17 is parallel to the front-rear direction when printing is performed on the print object 2 with a cylindrical outer shape. Also, the inclination of the UV irradiator 17 is adjusted, and the UV irradiator 17 is installed, such that the UV ray emission surface of the UV irradiator 17 is parallel to the left end of the print object 2 as illustrated in FIG. 8 when printing is performed on the print object 2 with a frustoconical or conical outer shape.

### Configurations of Cover, Second Cover, Cover Position Adjustment Mechanism, and Third Cover

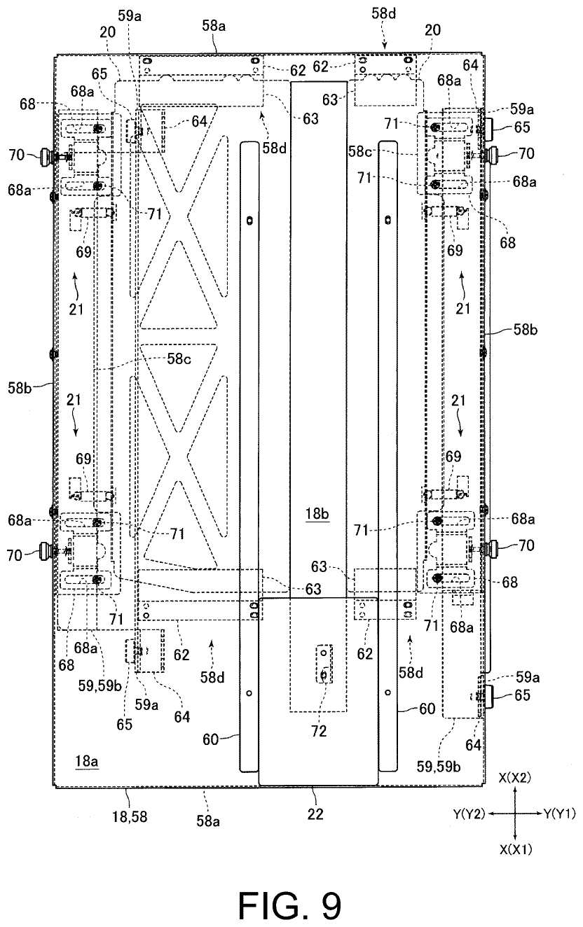

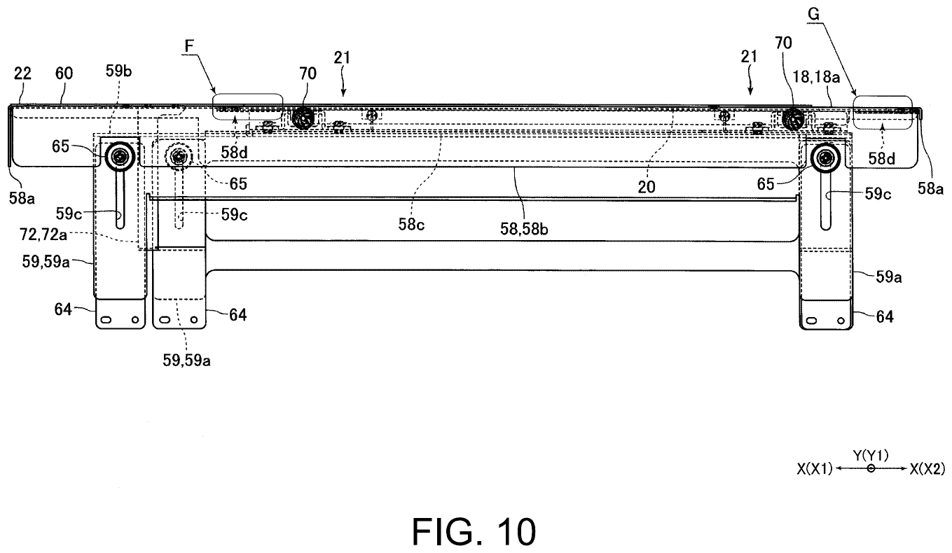

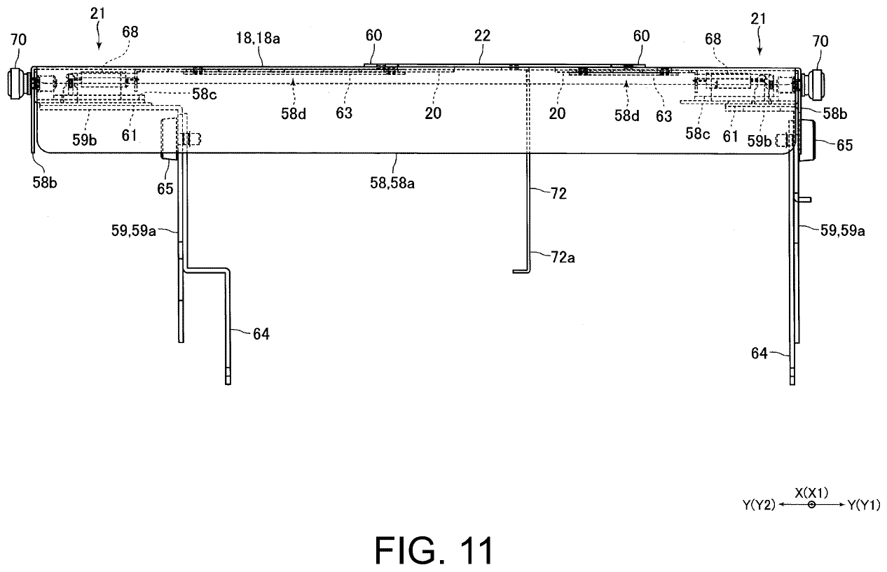

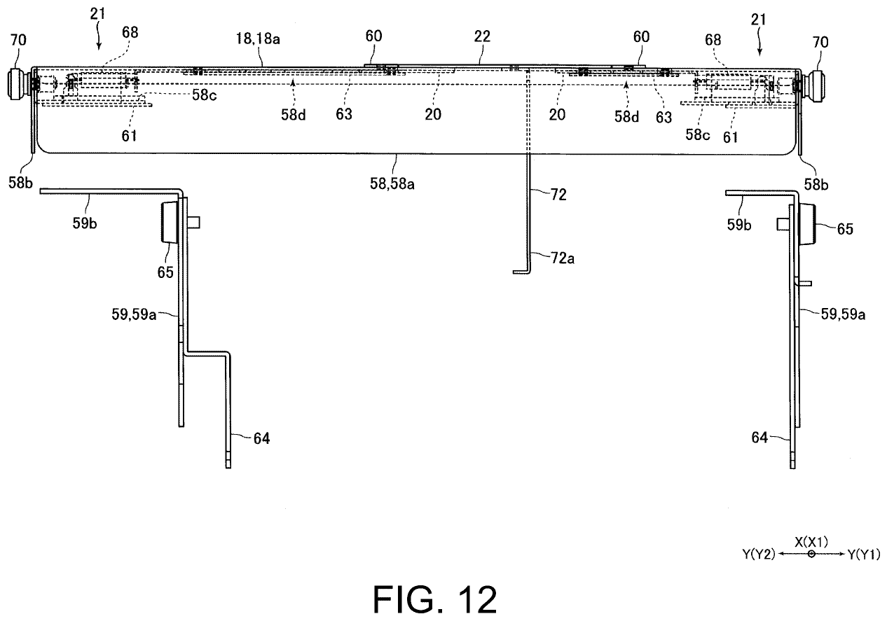

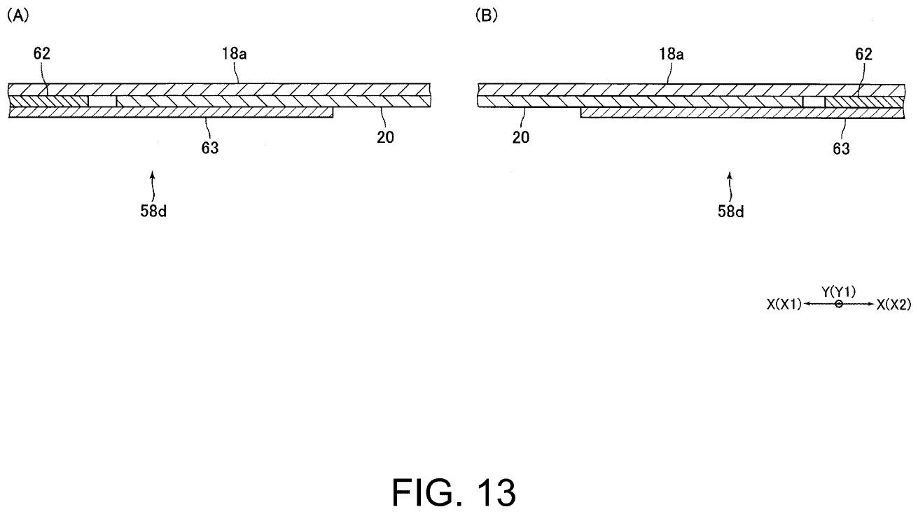

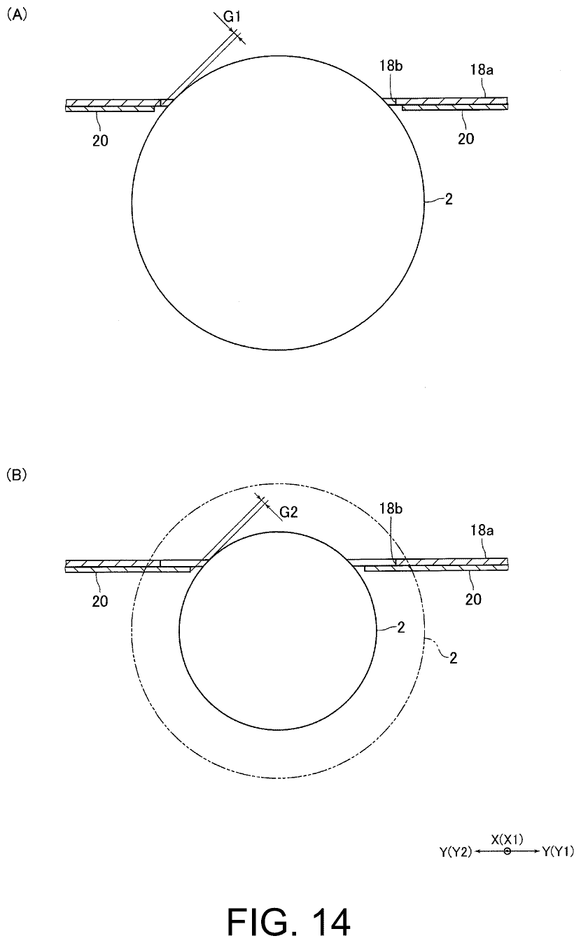

FIG. 9 is a plan view of the cover 18, the second covers 20, the cover position adjustment mechanisms 21, the third cover 22, and the like illustrated in FIG. 3. FIG. 10 is a side view of the cover 18, the second covers 20, the cover position adjustment mechanisms 21, the third cover 22, and the like illustrated in FIG. 9. FIG. 11 is a front view of the cover 18, the second covers 20, the cover position adjustment mechanisms 21, the third cover 22, and the like illustrated in FIG. 9. FIG. 12 is a front view illustrating a state where a cover upper portion 58 and cover lower portions 59 illustrated in FIG. 11 are separated. In FIG. 13, (A) is an enlarged view for explaining a configuration of a portion F in FIG. 10, and (B) is an enlarged view for explaining a configuration of a portion G in FIG. 10. FIG. 14 is a front view for explaining a disposition relationship of the cover portion 18a, the second covers 20, and the print object 2 illustrated in FIG. 9.

The cover 18 includes the cover upper portion 58 including a cover portion 18a and the cover lower portions 59 to which the cover upper portion 58 is attached on a side of an upper end thereof. The cover 18 in the present embodiment includes one cover upper portion 58 and two cover lower portions 59. The two cover lower portions 59 are disposed in a state where a clearance is left therebetween in the left-right direction. The cover lower portion 59 disposed on the right side supports a right end portion of the cover upper portion 58 from the lower side, and the cover lower portion 59 disposed on the left side supports a left end portion of the cover upper portion 58 from the lower side. In the present embodiment, the position of the cover 18 in the up-down direction is adjustable. Specifically, the positions of the cover lower portions 59 in the up-down direction are adjustable.

The cover portion 18a is formed into a rectangular flat plate shape. The cover portion 18a is disposed such that the thickness direction of the cover portion 18a and the up-down direction coincide with each other. Also, the cover portion 18a is disposed such that the long side direction of the cover portion 18a and the front-rear direction coincide with each other. The cover portion 18a configures the upper surface of the cover 18 and also configures the upper surface of the cover upper portion 58.

The opening 18b is a through-hole that penetrates through the cover portion 18a in the up-down direction. The opening 18b is formed into a rectangular shape that is thin and long in the front-rear direction. The length of the opening 18b in the front-rear direction is longer than the length of the print object 2 that is the longest among print objects 2 on which printing is performed by the printing apparatus 1. Guide plates 60 to position the third cover 22 in the left-right direction are fixed to the upper surface of the cover portion 18a. The guide plates 60 are formed into a rectangular flat plate shape that is thin and long in the front-rear direction. The guide plates 60 are disposed at two locations in a state where a clearance is left therebetween in the left-right direction. The two guide plates 60 are disposed with the opening 18b sandwiched therebetween in the left-right direction.

The cover upper portion 58 includes two flat plate-shaped side plate portions 58a configuring side surfaces of the cover upper portion 58 in the front-rear direction and two flat plate-shaped side plate portions 58b configuring side surfaces of the cover upper portion 58 in the left-right direction. The side plate portions 58a are disposed such that the thickness direction of the side plate portions 58a and the front-rear direction coincide with each other, and the side plate portions 58b are disposed such that the thickness direction of the side plate portions 58b and the left-right direction coincide with each other. The side plate portions 58a are connected to both ends of the cover portion 18a in the front-rear direction, and the side plate portions 58b are connected to both ends of the cover portion 18a in the left-right direction.

In addition, the cover upper portion 58 includes attachment portions 58c to which a pressing member 68 that configures a part of the cover position adjustment mechanisms 21 and will be described later is attached, and holding portions 58d holding the second covers 20. The attachment portions 58c are formed into a substantially rectangular flat plate shape that is thin and long in the front-rear direction. The attachment portions 58c are disposed such that the thickness direction of the attachment portion 58c and the up-down direction coincide with each other. The attachment portions 58c are disposed below the cover portion 18a. Also, the attachment portions 58c are disposed at two locations, namely a right end portion and a left end portion of the cover upper portion 58. A magnet sheet 61 which is a sheet-shaped permanent magnet is attached to lower surfaces of the attachment portions 58c. In other words, the cover upper portion 58 includes the magnet sheet 61.

The holding portions 58d are disposed at two locations at the rear end portion of the cover upper portion 58 with a clearance left therebetween in the left-right direction, and are disposed at two locations on a side further forward than the center of the cover upper portion 58 in the front-rear direction in a state where a clearance is left therebetween in the left-right direction. The two holding portions 58d disposed at the rear end portion of the cover upper portion 58 are disposed on both sides of the opening 18b in the left-right direction. Similarly, the two holding portions 58d disposed on the side further forward than the center of the cover upper portion 58 in the front-rear direction are disposed on both sides of the opening 18b in the left-right direction.

Each holding portion 58d is configured of a flat plate-shaped fixation plate 62 that is fixed to a lower surface of the cover portion 18a and a flat plate-shaped placement plate 63 that is fixed to a lower surface of the fixation plate 62. The placement plate 63 projects on the side further inward than the fixation plate 62 in the front-rear direction. An upper surface of the placement plate 63 is a plane that perpendicularly intersects the up-down direction. As illustrated in FIG. 13, a gap is formed between the lower surface of the cover portion 18a and the upper surface of the placement plate 63. Both end portions of the second cover 20 in the front-rear direction are disposed in the gap.

The cover lower portions 59 are formed of a magnetic material. For example, the cover lower portions 59 are formed of a metal material with magnetism. The cover lower portions 59 are fixed to a fixation frame 64. A lower end portion of the fixation frame 64 is fixed to the lower frame 41. The fixation frame 64 is fixed to four locations, namely a right front end, a right rear end, a left front end, and a left rear end of the lower frame 41. Each cover lower portion 59 includes fixed portions 59a that are fixed to the fixation frame 64 and a placement portion 59b on which the attachment portion 58c is placed.

The placement portion 59b is formed into a rectangular flat plate shape that is thin and long in the front-rear direction. The placement portion 59b is disposed such that the thickness direction of the placement portion 59b and the up-down direction coincide with each other. The placement portion 59b configures an upper surface of the cover lower portion 59. As described above, the cover lower portion 59 is made of a magnetic material. In other words, the placement portion 59b is formed of a magnetic material. The cover upper portion 58 is fixed to the upper surface of the placement portion 59b with a magnetic adsorption force caused between the magnet sheet 61 and the upper surface of the placement portion 59b. In other words, the cover upper portion 58 is attached to the cover lower portions 59 with a magnetic adsorption force generated between the magnet sheet 61 and the upper surface of the placement portion 59b.

In the present embodiment, the cover upper portion 58 attached to the cover lower portions 59 is positioned in the horizontal direction with respect to the cover lower portions 59 by inner side surfaces of the side plate portions 58b in the left-right direction, an end surface of the placement portion 59b, and the like. Therefore, the cover upper portion 58 is automatically positioned in the horizontal direction with respect to the cover lower portions 59 by the cover upper portion 58 being attached to the cover lower portions 59.

The fixed portions 59a are disposed at two locations, namely a front end portion and a rear end portion of each cover lower portion 59. As illustrated in FIG. 10, guide holes 59c to guide the cover lower portion 59 in the up-down direction with respect to the fixation frame 64 are formed in the fixed portions 59a. The guide holes 59c penetrate through the fixed portions 59a in the left-right direction. The guide holes 59c are formed into a long hole shape that is thin and long in the up-down direction. Fixing screws 65 to fix the cover lower portion 59 to the fixation frame 64 are inserted into the guide holes 59c. Screw holes with which the fixing screws 65 are engaged are formed in the fixation frame 64.

Once the fixing screws 65 are loosened, it is possible to cause the cover lower portion 59 to be lifted and lowered with respect to the lower frame 41 and the fixation frame 64. Also, the position of the cover lower portion 59 in the up-down direction is adjusted by causing the cover lower portion 59 to be lifted and lowered. In other words, once the fixing screws 65 are loosened, it is possible to cause the cover 18 to be lifted and lowered with respect to the lower frame 41 and the fixation frame 64, and the position of the cover 18 in the up-down direction is adjusted by causing the cover 18 to be lifted and lowered.

The second covers 20 are configured mainly of flat plate portions formed into a substantially rectangular flat plate shape that is thin and long in the front-rear direction. The flat plate portions of the second covers 20 are disposed such that the thickness direction of the second covers 20 and the up-down direction coincide with each other. Brushing treatment is performed on the lower surfaces of the flat plate surfaces of the second covers 20. The second covers 20 are disposed below the cover portion 18a. As described above, both end portions of the second covers 20 in the front-rear direction are disposed in the gap between the lower surface of the cover portion 18a and the upper surface of the placement plate 63, and the second covers 20 are held by the cover 18. Specifically, the second covers 20 are held by the cover upper portion 58. Moreover, the second covers 20 are held by the cover 18 such that the second covers 20 are slidable in the left-right direction.

The length of the second covers 20 in the front-rear direction is shorter than the length of the opening 18b in the front-rear direction. The rear ends of the second covers 20 and the rear end of the opening 18b are disposed at substantially the same position in the front-rear direction. One second cover 20 out of the two second covers 20 is disposed on the side further rightward than the center of the opening 18b in the left-right direction and is able to block a part of the opening 18b from the right side. The other second cover 20 is disposed on the side further leftward than the center of the opening 18b in the left-right direction and is able to block a part of the opening 18b from the left side.

The cover position adjustment mechanisms 21 are disposed at two locations outside the front end portions of the two second covers 20 in the left-right direction and two locations outside the rear end portions of the two second covers 20 in the left-right direction. The cover position adjustment mechanisms 21 are held by the cover upper portion 58. Each cover position adjustment mechanism 21 includes a pressing member 68 that comes into contact with the second cover 20 from the outer side of the left-right direction and presses the second cover 20 inward in the left-right direction, a tension coil spring 69 that biases the second cover 20 outward in the left-right direction, and an adjustment screw 70 that is rotatably held by the cover 18 and is engaged with the pressing member 68.

The pressing member 68 is held by the cover 18 such that the pressing member 68 is slidable in the left-right direction. The pressing member 68 is placed on the attachment portion 58c of the cover upper portion 58. The pressing member 68 is disposed below the cover portion 18a. The pressing member 68 is disposed outside the two second covers 20 in the left-right direction. The pressing member 68 disposed on the right side comes into contact with a right end surface of the second cover 20 disposed on the right side and presses the second cover 20 leftward. The pressing member 68 disposed on the left side comes into contact with a left end surface of the second cover 20 disposed on the left side and presses the second cover 20 rightward.

As illustrated in FIG. 9, a guide hole 68a to guide the pressing member 68 in the left-right direction is formed in the pressing member 68. A guide screw 71 is inserted into the guide hole 68a from the upper side. A screw hole with which the guide screw 71 is engaged is formed in the attachment portion 58c. The pressing member 68 is slidable in the left-right direction along the guide screw 71. Also, a screw hole with which the adjustment screw 70 is engaged is formed in the pressing member 68.

One end portion of the tension coil spring 69 is engaged with the second cover 20. The other end portion of the tension coil spring 69 is engaged with a spring engagement portion formed in the attachment portion 58c. The tension coil spring 69 is disposed outside the two second covers 20 in the left-right direction. The tension coil spring 69 disposed on the right side biases the second cover 20 disposed on the right side rightward, and the tension coil spring 69 disposed on the left side biases the second cover 20 disposed on the left side leftward. The adjustment screw 70 is a thumbscrew. The adjustment screw 70 is turnably held by the side plate portion 58b. A head portion of the adjustment screw 70 is disposed outside the side plate portion 58b in the left-right direction.

In the present embodiment, each second cover 20 slides in the left-right direction by turning the adjustment screw 70. Also, since the cover position adjustment mechanisms 21 are disposed on the front end side and the rear end side of the second covers 20 in the present embodiment, it is possible to adjust the inclination of the second covers 20 with respect to the front-rear direction in a view from the up-down direction as illustrated in FIG. 8 by causing the positions of the pressing members 68 disposed on the front side in the left-right direction and the positions of the pressing members 68 disposed on the rear side in the left-right direction to deviate from each other.

The third cover 22 is formed into a rectangular flat plate shape. As described above, the third cover 22 is placed on the cover portion 18a. The third cover 22 is disposed between the two guide plates 60. The third cover 22 blocks a front end side part of the opening 18b. A front end of the third cover 22 is disposed on the side further forward than the front end of the opening 18b. A detected member 72 including a detected portion 72a that is to be detected by the second detection mechanism 24 is attached to the third cover 22. The detected member 72 is fixed to a lower surface of the third cover 22. The detected member 72 extends downward from the lower surface of the third cover 22, and a lower end portion of the detected member 72 serves as the detected portion 72a.

In the present embodiment, the position of the cover 18 in the up-down direction and the positions of the second covers 20 in the left-right direction are adjusted in accordance with the outer diameter of the print object 2. Specifically, in a case where the outer diameter of the print object 2 is relatively large, for example, the position of the cover 18 in the up-down direction and the positions of the second covers 20 in the left-right direction are adjusted such that a gap G1 between edges of the opening 18b in the left-right direction and the outer peripheral surface of the print object 2 has a necessary minimum size as illustrated in (A) of FIG. 14. Also, in a case where the outer diameter of the print object 2 is relatively small, for example, the position of the cover 18 in the up-down direction and the positions of the second covers 20 in the left-right direction are adjusted such that a gap G2 between the end surfaces of the second covers 20 and the outer peripheral surface of the print object 2 has a necessary minimum size as illustrated in (B) of FIG. 14.

In the present embodiment, the inclination of the second covers 20 is adjusted in accordance with the shape of the print object 2 as illustrated in FIG. 8 when printing is performed on the print object 2 with a frustoconical or conical outer shape. Specifically, the inclination of the second covers 20 is adjusted in accordance with the shape of the print object 2 such that the gap G2 between the end surfaces of the second covers 20 and the outer peripheral surface of the print object 2 is constant over the entire region in the front-rear direction. The gaps G1 and G2 are, for example, 2 (mm). Also, shim plates (for example, shim plates with a thickness of 2 (mm)) are disposed between the end surfaces of the second covers 20 and the outer peripheral surface of the print object 2, the second covers 20 are caused to move, and the end surfaces of the second covers 20 and the outer peripheral surface of the print object 2 are pressed against the shim plate, when the adjustment of the second covers 20 in the left-right direction and the adjustment of the inclination are performed.

In the present embodiment, the position of the third cover 22 in the front-rear direction is caused to deviate in accordance with the length of the print object 2. In a case where the length of the print object 2 is relatively short, and the third cover 22 cannot cover the front end portion of the opening 18b, an additional cover is disposed in front of the third cover 22. However, a plurality of types of third covers 22 with different lengths in the front-rear direction may be prepared, and a third cover 22 with which the entire front end-side part of the opening 18b is covered may be selected and attached.

### Configurations of First Detection Mechanism and Second Detection Mechanism

FIG. 15 is a plan view for explaining the configuration of the portion E in FIG. 4.

The first detection mechanism 23 is an interlock switch including a contact member configuring a contact portion and a lever 23a that presses the contact member (see FIG. 6). The first detection mechanism 23 is attached to the third holding portion 34. The first detection mechanism 23 is disposed below the second holding portion 33. The lever 23a is disposed above the main body portion of the first detection mechanism 23. When the print object 2 is not attached to the rotation mechanism 16, the second holding portion 33 is inclined on the side of the first holding portion 28 with a biasing force of the compression coil spring 35, and the lever 23a is not in contact with the contact member (see (C) of FIG. 6). Therefore, the first detection mechanism 23 is in an OFF state.

Once the print object 2 is attached to the rotation mechanism 16 in this state, the second holding portion 33 is turned against the biasing force of the compression coil spring 35 and presses the lever 23a (see (A) and (B) of FIG. 6). Once the lever 23a pressed by the second holding portion 33 presses the contact member, the first detection mechanism 23 is brought into an ON state, and the second holding portion 33 is detected by the first detection mechanism 23. In other words, once the print object 2 is attached to the rotation mechanism 16, the second holding portion 33 is turned with respect to the third holding portion 34 against the biasing force of the compression coil spring 35 up to the position where the second holding portion 33 is detected by the first detection mechanism 23. Also, the fact that the print object 2 is being held by the rotation mechanism 16 is detected by the first detection mechanism 23 by the second holding portion 33 being detected by the first detection mechanism 23.

Similarly to the first detection mechanism 23, the second detection mechanism 24 is an interlock switch including a contact member configuring a contact portion and a lever 24a that presses the contact member. The second detection mechanism 24 is fixed to a fixation member 73. The fixation member 73 is fixed to the second holding portion 33. In other words, the second detection mechanism 24 is attached to the second holding portion 33 via the fixation member 73. The second detection mechanism 24 is disposed in front of the second rotating portion 32. The lever 24a is disposed in front of the main body portion of the second detection mechanism 24. As illustrated in FIG. 15, a guide groove 73a to guide the detected portion 72a of the detected member 72 to the lever 24a is formed in the fixation member 73. The guide groove 73a is formed from the front end of the fixation member 73 toward the rear side.

Once the third cover 22 is placed at a predetermined position of the cover portion 18a in a state where the print object 2 is held by the rotation mechanism 16, the detected portion 72a presses the lever 24a. Once the lever 24a pressed by the detected portion 72a presses the contact member, the second detection mechanism 24 is brought into an ON state, and the detected portion 72a is detected by the second detection mechanism 24. In other words, once the third cover 22 is placed at a predetermined position of the cover portion 18a in a state where the print object 2 is held by the rotation mechanism 16, the detected portion 72a is detected by the second detection mechanism 24. Also, the fact that the third cover 22 is being placed on the cover portion 18a is detected by the second detection mechanism 24 by the detected portion 72a being detected by the second detection mechanism 24.

In the present embodiment, once the fact that the print object 2 is being held by the rotation mechanism 16 is detected by the first detection mechanism 23, irradiation with UV rays by the UV irradiator 17 is enabled. More specifically, once the fact that the print object 2 is being held by the rotation mechanism 16 is detected by the first detection mechanism 23, and the fact that the third cover 22 is being placed on the cover portion 18a is detected by the second detection mechanism 24, the irradiation with UV rays by the UV irradiator 17 is enabled.

### Method for Adjusting UV Irradiation Device

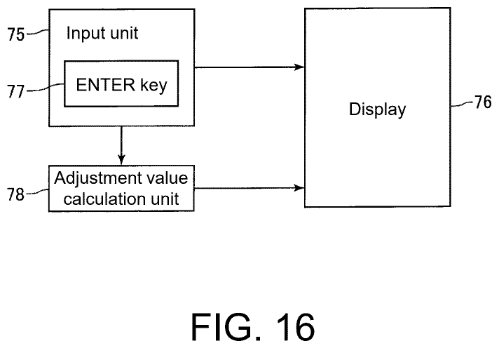

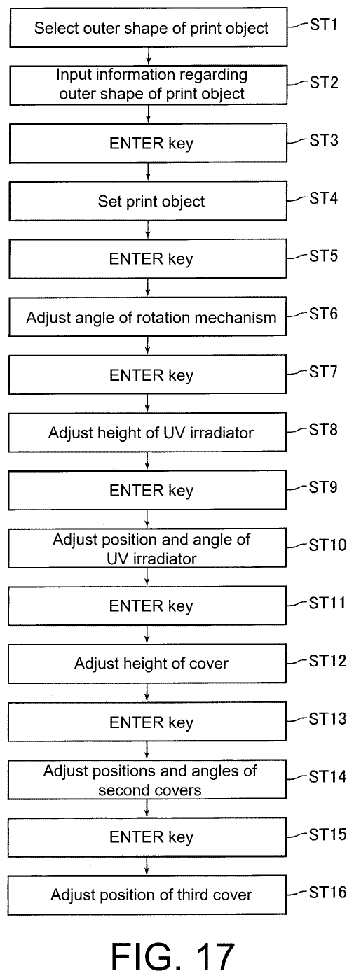

FIG. 16 is a block diagram illustrating a configuration for performing mechanical adjustment of the UV irradiation device 4 illustrated in FIG. 3. FIG. 17 is a process diagram for explaining a procedure for mechanical adjustment of the UV irradiation device 4 illustrated in FIG. 3.

As described above, the angle (inclination) of the rotation mechanism 16 with respect to the horizontal direction in a view from the left-right direction is adjustable in the UV irradiation device 4. Furthermore, in the UV irradiation device 4, the height (position in the up-down direction) of the UV irradiator 17, the position of the UV irradiator 17 in the left-right direction, the angle of the UV irradiator 17 with respect to an axial center of the print object 2 in a view from the up-down direction, the height (the position in the up-down direction) of the cover 18, the position of each of the two second covers 20 in the left-right direction, the angles of the second cover 20 with respect to the axial center of the print object 2 in a view from the up-down direction, and the position of the third cover 22 in the front-rear direction are adjustable. In other words, various mechanical adjustments of the UV irradiation device 4 are possible.

Mechanical adjustment items of the UV irradiation device 4 before printing is performed on the print object 2 by the printing apparatus 1 include adjustment of the angle of the rotation mechanism 16 with respect to the horizontal direction in a view from the left-right direction, adjustment of the height of the UV irradiator 17, adjustment of the position of the UV irradiator 17 in the left-right direction and the angle of the UV irradiator 17 with respect to the axial center of the print object 2 in a view from the up-down direction, adjustment of the height of the cover 18, adjustment of the positions of the two second covers 20 in the left-right direction and the angle of the second cover 20 with respect to the axial center of the print object 2 in a view from the up-down direction, and adjustment of the position of the third cover 22 in the front-rear direction. In other words, there are a plurality of mechanical adjustment items of the UV irradiation device 4 before printing is performed on the print object 2 by the printing apparatus 1.

The UV irradiation device 4 includes, as configurations to perform mechanical adjustment of the UV irradiation device 4, an input unit 75 used by an operator of the UV irradiation device 4 to input information regarding the outer shape of the print object 2 and a display 76 that is a display unit to display the mechanical adjustment items of the UV irradiation device 4. Through the input unit 75, various operations for mechanically adjusting the UV irradiation device 4 are performed in addition to the input of the information regarding the outer shape of the print object 2. The input unit 75 includes various operation keys. The operation keys include an ENTER key 77. The input unit 75 and the display 76 are installed on an operation panel of the printing apparatus 1. The operation panel is attached to a main body frame 9. Note that the operation panel may be attached to the UV irradiation device 4.

In a case where the outer shape of the print object 2 to be attached to the UV irradiation device 4 is a frustoconical or conical shape, the maximum outer shape of the print object 2 (the outer diameter of the part of the print object 2 where the outer diameter is the largest), the minimum outer shape of the print object 2 (the outer diameter of the part of the print object 2 where the outer diameter is the smallest), and the length of the print object 2 are input to the input unit 75. Also, in a case where the outer shape of the print object 2 to be attached to the UV irradiation device 4 is a cylindrical shape, the outer diameter of the print object 2 is input to the input unit 75.

The UV irradiation device 4 includes an adjustment value calculation unit 78 that calculates a predetermined adjustment value of the UV irradiation device 4 on the basis of the information regarding the outer shape of the print object 2 input to the input unit 75. The adjustment value calculation unit 78 is mounted on, for example, a control board built in the operation panel of the printing apparatus 1. In a case where the outer shape of the print object 2 to be attached to the UV irradiation device 4 is a frustoconical or conical shape, the adjustment value calculation unit 78 calculates the angle of the rotation mechanism 16 with respect to the horizontal direction in a view from the left-right direction after adjustment and the height of the UV irradiator 17 after adjustment on the basis of the information regarding the outer shape of the print object 2 input to the input unit 75.

In a case where the outer shape of the print object 2 to be attached to the UV irradiation device 4 is a frustoconical or conical shape, the mechanical adjustment of the UV irradiation device 4 is performed in the procedure illustrated in FIG. 17. First, the operator performs a predetermined operation on the input unit 75 to select the outer shape of the print object 2 (Step ST1). Specifically, the operator performs a predetermined operation on the input unit 75 to select which of the frustoconical or conical shape and the cylindrical shape the outer shape of the print object 2 is. In the procedure illustrated in FIG. 17, the operator selects that the outer shape of the print object 2 is a frustoconical or conical shape in Step ST1.

Thereafter, the operator performs a predetermined operation on the input unit 75 to input information regarding the outer shape of the print object 2 (Step ST2). Specifically, the operator inputs the maximum outer diameter of the print object 2, the minimum outer diameter of the print object 2, and the length of the print object 2. At this time, the operator measures the dimensions of the print object 2 using, for example, a caliper, and inputs the maximum outer diameter of the print object 2, the minimum outer diameter of the print object 2, and the length of the print object 2 to the input unit 75. Thereafter, the operator presses the ENTER key 77 (Step ST3). Once the ENTER key 77 is pressed in Step ST3, the adjustment value calculation unit 78 calculates the angle of the rotation mechanism 16 with respect to the horizontal direction in a view from the left-right direction after adjustment and the height of the UV irradiator 17 after adjustment on the basis of the information regarding the outer shape of the print object 2 input to the input unit 75.

Thereafter, the operator sets the print object 2 in the rotation mechanism 16 (that is, the operator attaches the print object 2 to the rotation mechanism 16; Step ST4) and then presses the ENTER key 77 (Step ST5). Once the ENTER key 77 is pressed in Step ST5, the display 76 displays an adjustment item. Specifically, the display 76 performs predetermined display to notify the operator of the fact that “adjustment of the angle of the rotation mechanism 16 with respect to the horizontal direction in a view from the left-right direction”, which is one of the adjustment items, is to be performed. In addition, the display 76 displays the angle of the rotation mechanism 16 after the adjustment calculated by the adjustment value calculation unit 78. Note that the display 76 may include one screen on which the adjustment item and the angle of the rotation mechanism 16 after the adjustment are displayed together, or may separately include a screen on which the adjustment item is displayed and a screen on which the angle of the rotation mechanism 16 after the adjustment is displayed.

The operator who has checked the display on the display 76 adjusts the angle of the rotation mechanism 16 with respect to the horizontal direction in a view from the left-right direction (Step ST6). In other words, the operator performs the adjustment of the adjustment item displayed on the display 76. In Step ST6, the operator performs the adjustment of the angle of the rotation mechanism 16 such that the upper end of the print object 2 is parallel to the front-rear direction. In the present embodiment, a scale plate on which a scale indicating the angle of the turning frame 40 with respect to the front-rear direction in a view from the left-right direction is marked is fixed to the guide frames 44. In Step ST6, the operator first adjusts the angle of the rotation mechanism 16 while checking the scale marked on the scale plate such that the angle of the rotation mechanism 16 becomes the angle displayed on the display 76. Thereafter, the operator places a level on the upper end of the print object 2 and finely adjusts the angle of the rotation mechanism 16 such that the upper end of the print object 2 is parallel to the front-rear direction.

Once the adjustment in Step ST6 ends, the operator presses the ENTER key 77 (Step ST7). Once the ENTER key 77 is pressed in Step ST7, the display 76 displays the next adjustment item. Specifically, the display 76 performs predetermined display to notify the operator of the fact that “adjustment of the height of the UV irradiator 17”, which is the next adjustment item, is to be performed. In addition, the display 76 displays the height of the UV irradiator 17 after the adjustment calculated by the adjustment value calculation unit 78.

The operator who has checked the display on the display 76 adjusts the height of the UV irradiator 17 (Step ST8). In the present embodiment, a scale plate on which a scale indicating the height of the UV irradiator 17 is marked is fixed to the guide frame 53. In Step ST8, the operator adjusts the height of the UV irradiator 17 while checking the scale marked on the scale plate such that the height of the UV irradiator 17 becomes the height displayed on the display 76. Once the adjustment in Step ST8 ends, the operator presses the ENTER key 77 (Step ST9).

Once the ENTER key 77 is pressed in Step ST9, the display 76 displays the next adjustment item. Specifically, the display 76 performs predetermined display to notify the operator of the fact that “adjustment of the position of the UV irradiator 17 in the left-right direction and the angle of the UV irradiator 17 with respect to the axial center of the print object 2 in a view from the up-down direction”, which are the next adjustment items, is to be performed. The operator who has checked the display on the display 76 adjusts the position of the UV irradiator 17 in the left-right direction and the angle of the UV irradiator 17 with respect to the axial center of the print object 2 in a view from the up-down direction (Step ST10).

Once the adjustment in Step ST10 ends, the operator presses the ENTER key 77 (Step ST11). Once the ENTER key 77 is pressed in Step ST11, the display 76 displays the next adjustment item. Specifically, the display 76 performs predetermined display to notify the operator of the fact that “adjustment of the height of the cover 18”, which is the next adjustment item, is to be performed. The operator who has checked the display on the display 76 adjusts the height of the cover 18 (Step ST12). In Step ST12, the height of the cover 18 is adjusted using a level such that the upper surfaces of the second covers 20 perpendicularly intersect the up-down direction.

Once the adjustment in Step ST12 ends, the operator presses the ENTER key 77 (Step ST13). Once the ENTER key 77 is pressed in Step ST13, the display 76 displays the next adjustment item. Specifically, the display 76 performs predetermined display to notify the operator of the fact that “adjustment of the positions of the second covers 20 in the left-right direction and the angles of the second covers 20 with respect to the axial center of the print object 2 in a view from the up-down direction”, which are the next adjustment items, is to be performed. The operator who has checked the display on the display 76 performs the adjustment of the positions of the second covers 20 in the left-right direction and the adjustment of the angles of the second covers 20 with respect to the axial center of the print object 2 in a view from the up-down direction (Step ST14). In Step ST14, the operator adjusts the positions and the angles of the second covers 20 by disposing shim plates between the end surfaces of the second covers 20 and the outer peripheral surface of the print object 2.

Once the adjustment in Step ST14 ends, the operator presses the ENTER key 77 (Step ST15). Once the ENTER key 77 is pressed in Step ST15, the display 76 displays the next adjustment item. Specifically, the display 76 performs predetermined display to notify the operator of the fact that “adjustment of the position of the third cover 22 in the front-rear direction”, which is the next adjustment item, is to be performed. The operator who has checked the display on the display 76 adjusts the position of the third cover 22 in the front-rear direction (Step ST16). Once the adjustment in Step ST16 ends, the mechanical adjustment of the UV irradiation device 4 before printing on the print object 2 is ended.

In this manner, once the adjustment of one adjustment item ends and the ENTER key 77 is pressed, the display 76 displays the next adjustment item. Also, the operator performs the adjustment of the adjustment item displayed on the display 76, then presses the ENTER key 77, and then performs adjustment of the next adjustment item displayed on the display 76. The ENTER key 77 in the present embodiment is an input key for the operator to input that one adjustment item has been completed. Also, once the information regarding the outer shape of the print object 2 is input to the input unit 75 in Step ST2, the display 76 can sequentially display the mechanical adjustment items of the UV irradiation device 4 in the present embodiment.

The mechanical adjustment of the UV irradiation device 4 is performed in the procedure illustrated in FIG. 17 even in a case where the outer shape of the print object 2 to be attached to the UV irradiation device 4 is a cylindrical shape. In this case, the operator selects that the outer shape of the print object 2 is a cylindrical shape in Step ST1. Also, the operator performs a predetermined operation on the input unit 75 to input the outer diameter of the print object 2 in Step ST2. Note that in this case, the operator presses the ENTER key 77 in Step ST7 without performing the adjustment of the angle of the rotation mechanism 16 in Step ST6. Also, the operator does not perform the adjustment of the angle of the UV irradiator 17 with respect to the axial center of the print object 2 in a view from the up-down direction in Step ST10. Also, the operator does not perform the adjustment of the angles of the second covers 20 with respect to the axial center of the print object 2 in a view from the up-down direction in Step ST14.

### Main Effects of Present Embodiment

As described above, once the information regarding the outer shape of the print object 2 is input to the input unit 75, the display 76 can sequentially display the mechanical adjustment items of the UV irradiation device 4 in the present embodiment. Therefore, according to the present embodiment, the operator can recognize what kind of mechanical adjustment is needed for the UV irradiation device 4 by the operator visually checking the adjustment items displayed on the display 76. In other words, according to the present embodiment, the operator can recognize what kind of mechanical adjustment is needed for the UV irradiation device 4 without checking an operation manual for the UV irradiation device 4. Therefore, according to the present embodiment, the operator can easily recognize what kind of mechanical adjustment is needed for the UV irradiation device 4.

In the present embodiment, once the adjustment of one adjustment item is ended and the ENTER key 77 is pressed, the display 76 displays the next adjustment item. Therefore, according to the present embodiment, the operator can easily recognize what kind of mechanical adjustment is needed for the UV irradiation device 4 by the operator visually checking the adjustment item displayed on the display 76 every time the adjustment of one adjustment item is ended and the operator presses the ENTER key 77 even if there are a plurality of adjustment items of the UV irradiation device 4. Also, according to the present embodiment, the adjustment items are sequentially displayed on the display 76 every time the ENTER key 77 is pressed, and it is thus only necessary for the operator to sequentially perform the mechanical adjustment of the UV irradiation device 4 in accordance with the display on the display 76. Therefore, according to the present embodiment, it is possible to efficiently and smoothly perform the adjustment of the UV irradiation device 4 even if there are a plurality of adjustment items.

In the present embodiment, the inclination of the rotation mechanism 16 with respect to the horizontal direction in a view from the left-right direction is adjustable, and the inclination of the rotation mechanism 16 is adjusted such that the upper end of the print object 2 is parallel to the front-rear direction when printing is performed on the print object 2 with a frustoconical or conical outer shape. Therefore, according to the present embodiment, it is possible to keep the distance between the outer peripheral surface of the print object 2 and the nozzle surface of the inkjet head 3 constant over the entire region of the print object 2 in the axis direction even in a case where printing is performed on the print object 2 with a frustoconical or conical outer shape. It is thus possible to perform appropriate printing on the print object 2 according to the present embodiment.

According to the present embodiment, the height of the UV irradiator 17, the position of the UV irradiator 17 in the left-right direction, and the angle of the UV irradiator 17 with respect to the axial center of the print object 2 in a view from the up-down direction are adjustable. Therefore, according to the present embodiment, it is possible to dispose the UV irradiator 17 at a more appropriate position for curing the ink adhering to the print object 2 even in a case where the outer shape and the outer diameter of the print object 2 on which printing is to be performed by the printing apparatus 1 change.

According to the present embodiment, the height of the cover 18, the positions of the second covers 20 in the left-right direction, and the angles of the second covers 20 with respect to the axial center of the print object 2 in a view from the up-down direction are adjustable. Also, according to the present embodiment, the position of the cover 18 in the up-down direction, the positions of the second covers 20 in the left-right direction, and the angles of the second covers 20 are adjusted in accordance with the outer shape and the outer diameter of the print object 2 such that the gap G1 between the edges of the opening 18b in the left-right direction and the outer peripheral surface of the print object 2 and the gap G2 between the end surfaces of the second covers 20 and the outer peripheral surface of the print object 2 have minimum necessary sizes. Therefore, in the present embodiment, it is possible to suppress irradiation of the nozzle surface of the inkjet head 3 with UV rays by the cover portion 18a and the second covers 20 even in a case where the UV irradiator 17 is disposed on the lateral side of the print object 2 and the outer shape and the outer diameter of the print object 2 change.

According to the present embodiment, the adjustment value calculation unit 78 calculates the angle of the rotation mechanism 16 with respect to the horizontal direction in a view from the left-right direction after the adjustment on the basis of the information regarding the outer shape of the print object 2 input to the input unit 75. According to the present embodiment, the display 76 displays the angle of the rotation mechanism 16 after the adjustment calculated by the adjustment value calculation unit 78. Therefore, the operator can easily recognize the angle of the rotation mechanism 16 after the adjustment by the operator visually checking the angle of the rotation mechanism 16 after the adjustment displayed on the display 76 even if the operator does not calculate the angle of the rotation mechanism 16 after the adjustment in the present embodiment. It is thus possible to reduce a burden on the operator according to the present embodiment.

According to the present embodiment, the adjustment value calculation unit 78 calculates the height of the UV irradiator 17 after the adjustment on the basis of the information regarding the outer shape of the print object 2 input to the input unit 75. According to the present embodiment, the display 76 displays the height of the UV irradiator 17 after the adjustment calculated by the adjustment value calculation unit 78. Therefore, according to the present embodiment, the operator can easily recognize the height of the UV irradiator 17 after the adjustment by visually checking the height of the UV irradiator 17 after the adjustment displayed on the display 76 even if the operator does not calculate the height of the UV irradiator 17 after the adjustment. It is thus possible to reduce a burden on the operator according to the present embodiment.

### Modification Example of Peripheral Portion of Rotation Mechanism

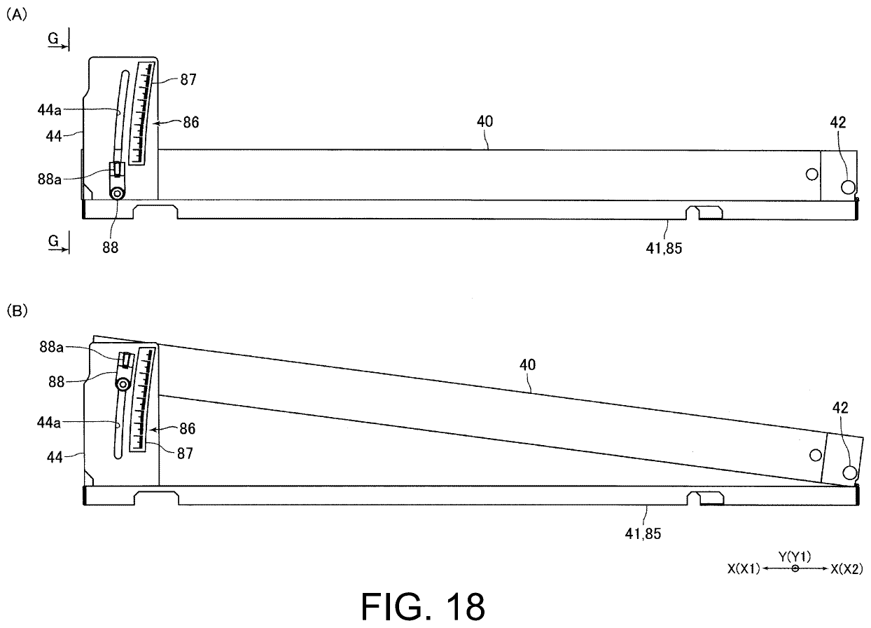

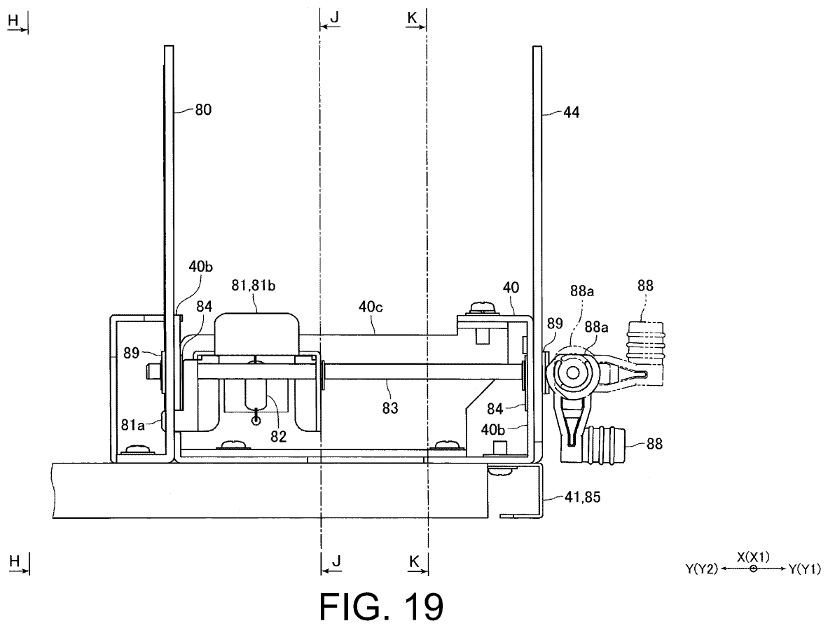

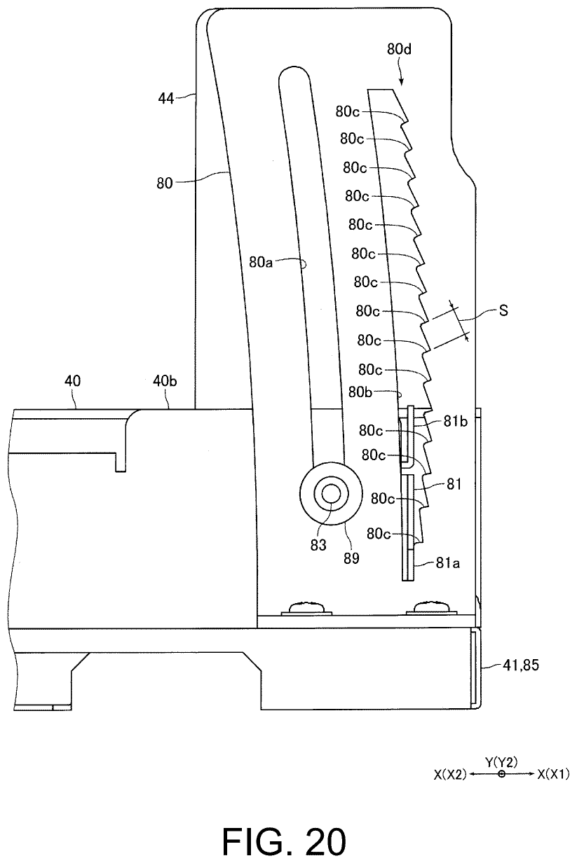

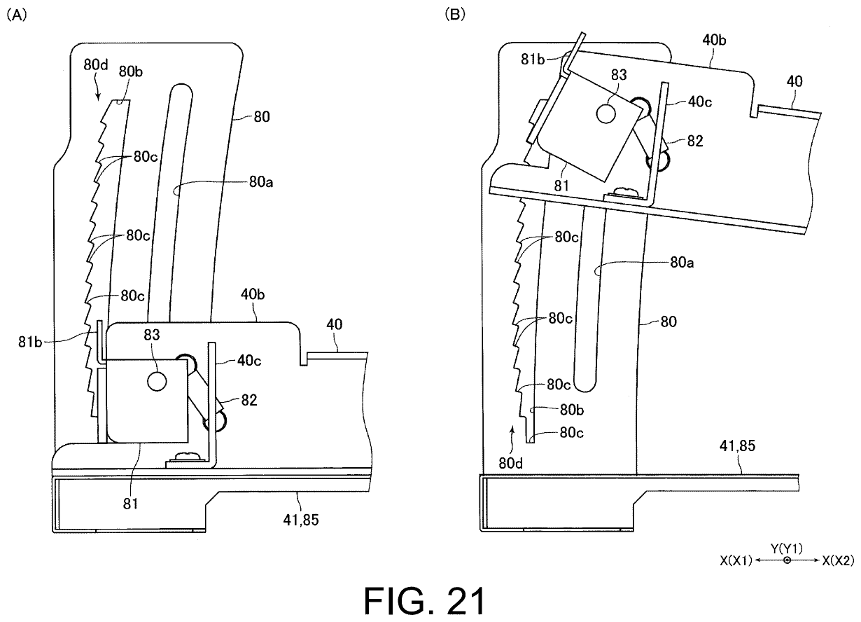

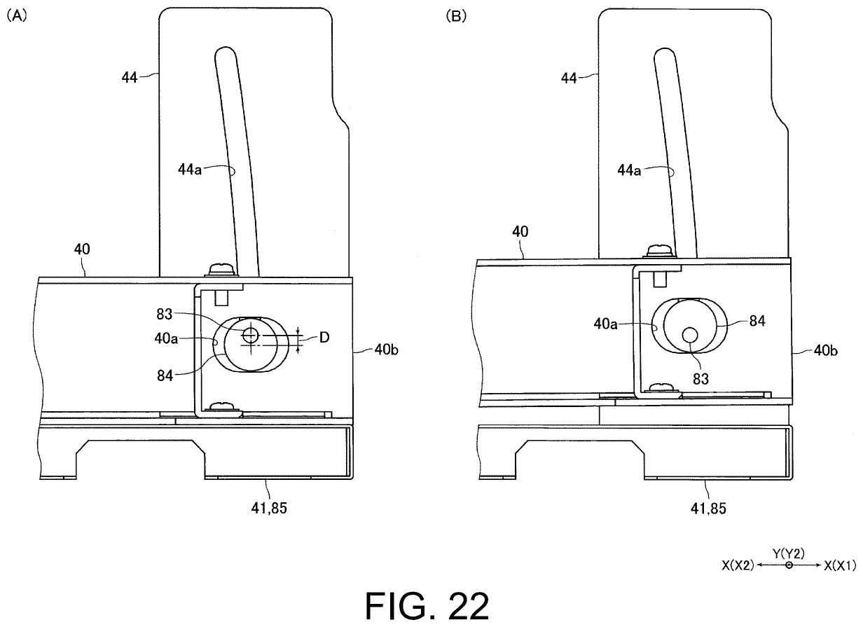

FIG. 18 is a side view for explaining a configuration of a peripheral portion of a rotation mechanism 16 according to another embodiment of the present invention. FIG. 19 is a diagram for explaining the configuration of the peripheral portion of the rotation mechanism 16 from a G-G direction in (A) of FIG. 18. FIG. 20 is a side view illustrating a support frame 80, an engagement member 81, and the like from an H-H direction in FIG. 19. FIG. 21 are diagrams for explaining a configuration of a J-J section in FIG. 19. FIG. 22 are diagrams for explaining a configuration of a K-K section in FIG. 19. Note that the same configurations as those in the aforementioned embodiment are denoted by the same reference signs in FIGS. 18 to 22.

Although the two guide frames 44 are fixed to the front end portion of the lower frame 41 in a state where a clearance is left therebetween in the left-right direction in the embodiment described above, a support frame 80 is fixed to a front end portion of a lower frame 41 instead of one guide frame 44 out of the two guide frames 44 in the modification example. In the modification example, the UV irradiation device 4 includes an engagement member 81 that is held by a rotation mechanism 16 (specifically, held by a turning frame 40) such that the engagement member 81 is able to turn with the left-right direction defined as a turning axis direction, a tension coil spring 82 that biases the engagement member 81 on one side of the turning direction of the engagement member 81 with respect to the rotation mechanism 16, a turning shaft 83 that serves as a turning center of the engagement member 81 with respect to the turning frame 40, and eccentric cams 84 fixed to the turning shaft 83.

As described above, the turning frame 40 is turnable with respect to the lower frame 41 with the left-right direction defined as a turning axis direction. Moreover, a support frame 43 is fixed to a rear end portion of the lower frame 41, and the turning center shaft 42 serving as a turning center of the turning frame 40 is attached to the support frame 43. In other words, the turning frame 40 is coupled to the support frame 43 such that the turning frame 40 is turnable with the left-right direction defined as the turning axis direction. In the modification example, the lower frame 41 and the support frame 43 configure a base frame 85 that has the rotation mechanism 16 coupled to a rear end portion thereof, which is one end portion in the front-rear direction, such that the turning of the rotation mechanism 16 with the left-right direction defined as a turning axis direction is enabled. A rear end portion of the turning frame 40 is turnably coupled to the rear end portion of the base frame 85. Note that illustration of the support frame 43 is omitted in FIG. 18.

The support frame 80 is fixed to a front end portion of the lower frame 41. In other words, the support frame 80 is fixed to the front end portion of the base frame 85, which is the other end portion in the front-rear direction. The guide frame 44 is disposed on the right side of the turning frame 40, and the support frame 80 is disposed on the left side of the turning frame 40. A guide hole 80a corresponding to the guide hole 44a of the guide frame 44 is formed in the support frame 80. Also, a vertically long through-hole 80b that penetrates through the support frame 80 in the left-right direction is formed in the support frame 80. The through-hole 80b is formed in front of the guide hole 80a.

A side surface of the through-hole 80b on the front side is a stepped portion 80d with a step shape where a plurality of stepped surfaces 80c aligned in the up-down direction are formed. In other words, the support frame 80 includes a stepped portion 80d with a step shape. The plurality of stepped surfaces 80c are aligned on an arc with the turning center shaft 42 included as a curvature center in a view from the left-right direction. The plurality of stepped surfaces 80c face upward. Steps S (see FIG. 20) between stepped surfaces 80c that are adjacent in the up-down direction are constant. Specifically, the steps S are constant in the circumferential direction around the turning center shaft 42 at the center.

A scale plate 87 on which a scale 86 indicating the angle of the turning frame 40 with respect to the front-rear direction in a view from the left-right direction is marked is fixed to the guide frame 44 or the support frame 80. In other words, the scale plate 87 on which the scale 86 indicating the angle of the rotation mechanism 16 with respect to the horizontal direction in a view from the left-right direction is marked is fixed to the guide frame 44 or the support frame 80.

The turning shaft 83 is disposed such that the axis direction of the turning shaft 83 and the left-right direction coincide with each other. The eccentric cams 84 are eccentric disk cams formed into a disk shape. The eccentric cams 84 are fixed to both end portions of the turning shaft 83, and the two eccentric cams 84 are turnable together with the turning shaft 83. The centers of the eccentric cams 84 deviate from the axial center of the rotation shaft 83. The amount of eccentricity D (see (A) of FIG. 22) which is the distance between the centers of the eccentric cams 84 and the axial center of the turning shaft 83 is equal to half the step S between the stepped surfaces 80c that are adjacent in the up-down direction.

Cam disposition holes 40a in which the eccentric cams 84 are disposed are formed in the turning frame 40 (see FIG. 22). Specifically, the cam disposition holes 40a are formed at front end portions of side surface portions 40b that configure side surfaces of the turning frame 40 in the left-right direction. The cam disposition holes 40a are formed into a long hole shape. The eccentric cams 84 are turnably held by the side surface portions 40b. In other words, the turning shaft 83 to which the eccentric cams 84 are fixed is turnably held by the turning frame 40 via the eccentric cams 84. Specifically, both end portions of the turning shaft 83 are turnably held by the front end portion of the turning frame 40 via the eccentric cams 84. The turning shaft 83 and the eccentric cams 84 are turnable with respect to the turning frame 40 with the left-right direction defined as a turning axis direction.

Both ends of the turning shaft 83 project further outward in the left-right direction than the turning frame 40. The right end portion of the turning shaft 83 is inserted into the guide hole 44a of the guide frame 44, and the left end portion of the turning shaft 83 is inserted into the guide hole 80a of the support frame 80. Also, the right end of the turning shaft 83 projects further rightward than the guide frame 44, and the left end of the turning shaft 83 projects further leftward than the support frame 80. A clamp lever 88 with an eccentric cam is attached to the right end portion of the turning shaft 83 projecting further rightward than the guide frame 44.

The engagement member 81 is disposed between the two side surface portions 40b in the left-right direction. Furthermore, the engagement member 81 is disposed to be adjacent to the right side of the side surface portion 40b disposed on the left side. An insertion hole into which the turning shaft 83 is inserted is formed in the engagement member 81. The engagement member 81 is turnably held by the front end portion of the turning frame 40 via the turning shaft 83 and the eccentric cam 84. Also, the turning shaft 83 is turnable with respect to the engagement member 81. The engagement member 81 includes a placement portion 81a placed on the stepped surfaces 80c (see FIGS. 19 and 20). The placement portion 81a is disposed at a front lower end portion of the engagement member 81 and is disposed further forward and downward than the turning shaft 83. Also, the placement portion 81a is disposed at a left end portion of the engagement member 81.

One end side of the tension coil spring 82 is engaged with a rear upper end portion of the engagement member 81. The other end portion of the tension coil spring 82 is engaged with a spring engagement portion 40c disposed at a front end portion of the turning frame 40. The spring engagement portion 40c is disposed behind the engagement member 81. The tension coil spring 82 biases the engagement member 81 in the clockwise direction (the clockwise direction in FIG. 21) around the turning shaft 83 at the center in a view from the right side. The placement portion 81a disposed at the front lower end portion of the engagement member 81 is disposed behind the stepped portion 80d. The tension coil spring 82 biases the engagement member 81 in the direction in which the placement portion 81a moves toward the stepped portion 80d.

The placement portion 81a is placed on the stepped surfaces 80c with the own weight of the rotation mechanism 16. Also, since the engagement member 81 is biased in the direction in which the placement portion 81a moves toward the stepped portion 80d, the placement portion 81a is automatically placed on the stepped surface 80c in accordance with the angle of the turning frame 40 with respect to the horizontal direction once the turning frame 40 is turned with respect to the base frame 85 such that the front end portion of the turning frame 40 moves upward.

Once the engagement member 81 is turned against the biasing force of the tension coil spring 82 (that is, the engagement member 81 is turned in the counterclockwise direction in a view from the right side such that the placement portion 81a moves away from the stepped portion 80d), the placement portion 81a is detached from the stepped surface 80c. Therefore, if the engagement member 81 is turned against the biasing force of the tension coil spring 82, it is possible to turn the turning frame 40 with respect to the base frame 85 such that the front end portion of the turning frame 40 is lowered. Note that a finger hooking portion 81b to turn the engagement member 81 against the biasing force of the tension coil spring 82 is formed at the front upper end portion of the engagement member 81.

In the modification example, it is possible to turn the turning frame 40 with respect to the base frame 85 if the eccentric cam 88a of the clamp lever 88 is disposed at the position indicated by the two-dotted dashed line in FIG. 19. On the other hand, if the clamp lever 88 is turned with the front-rear direction defined as a turning axis direction such that the eccentric cam 88a is disposed at the position indicated by the solid line in FIG. 19, a state where the front end portion of the turning frame 40 is fixed to the guide frame 44 and the support frame 80 is achieved, and a state where it is not possible to turn the turning frame 40 with respect to the base frame 85 is achieved.

Note that the turning shaft 83 is inserted into a washer 89 and the washer 89 is fixed to the turning shaft 83 on the left side of the support frame 80. Also, the turning shaft 83 is inserted into a washer 89 and the washer 89 is movable in the left-right direction with respect to the turning shaft 83 on the right side of the guide frame 44 and the left side of the clamp lever 88. Therefore, if the clamp lever 88 is turned such that the eccentric cam 88a is disposed at the position indicated by the solid line in FIG. 19, a state where the guide frame 44, the support frame 80, and the turning frame 40 are sandwiched between the two washers 89 and the front end portion of the turning frame 40 is fixed to the guide frame 44 and the support frame 80 is achieved.

In the modification example, the inclination of the rotation mechanism 16 with respect to the horizontal direction is adjusted by moving the eccentric cam 88a of the clamp lever 88 to the position indicated by the two-dotted dashed line in FIG. 19 and turning the turning frame 40 with respect to the base frame 85. When the inclination of the rotation mechanism 16 with respect to the horizontal direction is adjusted, the operator of the printing apparatus 1 first manually turns the turning frame 40 with respect to the base frame 85 such that the front end portion of the turning frame 40 is lifted. If the turning frame 40 is turned in this manner, the placement portion 81a is automatically placed on the stepped surface 80c in accordance with the angle of the turning frame 40 with respect to the horizontal direction. In the modification example, it is possible to change the inclination of the rotation mechanism 16 with respect to the horizontal direction at a pitch of 0.5°, for example, using the plurality of stepped surfaces 80c.

Thereafter, the operator turns the clamp lever 88 and thereby turns the eccentric cam 84 with the left-right direction defined as the turning axis direction. Since the eccentric cam 84 is turned with respect to the turning frame 40 and the engagement member 81 with the turning shaft 83 defined as a turning center, the front end portion of the turning frame 40 moves upward and downward with respect to the engagement member 81 by turning the eccentric cam 84. In other words, the turning frame 40 is turned with respect to the base frame 85. In this manner, since the front end portion of the turning frame 40 moves upward and downward with respect to the engagement member 81 and the turning frame 40 is turned with respect to the base frame 85 by turning the eccentric cam 84, it is possible to finely adjust the inclination of the rotation mechanism 16 with respect to the horizontal direction using the eccentric cam 84 in the modification example.

Also, since the amount of eccentricity D which is the distance between the center of the eccentric cam 84 and the axial center of the turning shaft 83 is equal to half the step S between the stepped surfaces 80c that are adjacent in the up-down direction in the modification example, it is possible to continuously adjust the inclination of the rotation mechanism 16 with respect to the horizontal direction even in a case where the inclination of the rotation mechanism 16 with respect to the horizontal direction is adjusted using the stepped portions 80d of the support frame 80 and the engagement member 81.

Note that the amount of eccentricity D may not be equal to half the step S. Also, the UV irradiation device 4 may not include the eccentric cam 84. Moreover, the turning frame 40 may be turned with respect to the base frame 85 by causing the front end portion of the turning frame 40 to move upward and downward using a screw member. In this case, the operator may manually rotate the screw member, or the UV irradiation device 4 may include a motor to cause the screw member to rotate.

### Modification Example of Peripheral Portion of UV Irradiator

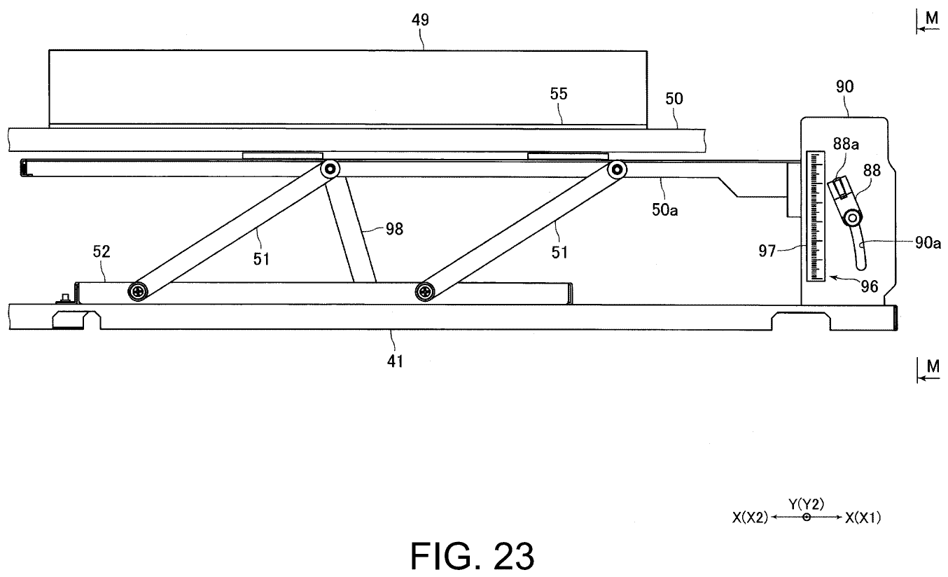

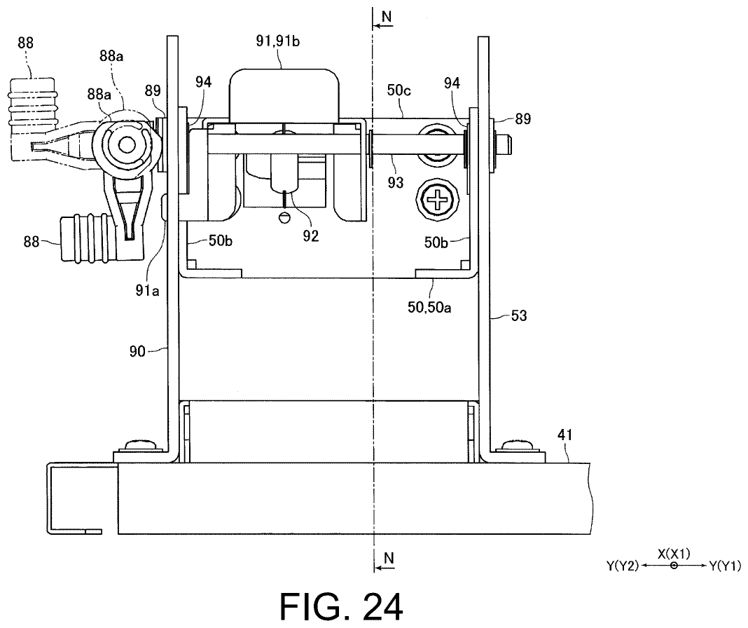

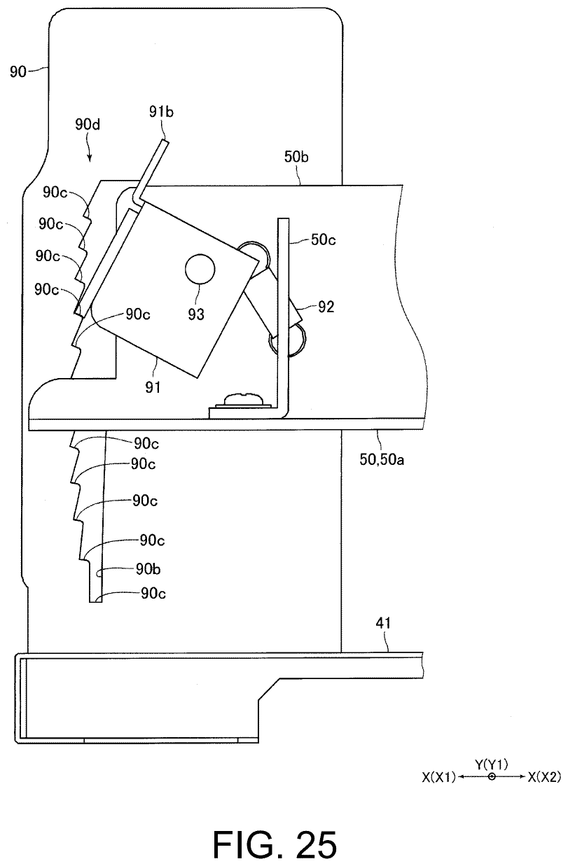

FIG. 23 is a side view for explaining a configuration of a peripheral portion of a UV irradiator 17 according to another embodiment of the present invention. FIG. 24 is a diagram for explaining the configuration of the peripheral portion of the UV irradiator 17 from an M-M direction in FIG. 23. FIG. 25 is a diagram for explaining a configuration of an N-N section in FIG. 24. Note that the same configurations as those in the aforementioned embodiment are denoted by the same reference signs in FIGS. 23 to 25.

Although the two guide frames 53 are disposed on the front end side of the lower frame 41 in a state where a clearance is left therebetween in the left-right direction in the aforementioned embodiment, a support frame 90 formed substantially similarly to the support frame 80 is disposed on the front end side of the lower frame 41 instead of one guide frame 53 out of the two guide frames 53 in this modification example. In the modification example, a UV irradiation device 4 includes an engagement member 91 that is held by a placement portion 50 to enable turning with the left-right direction defined as a turning axis direction, a tension coil spring 92 that biases the engagement member 91 on one side in the turning direction of the engagement member 91 with respect to the placement portion 50, a turning shaft 93 serving as a turning center of the engagement member 91 with respect to the placement portion 50, and an eccentric cam 94 fixed to the turning shaft 93.

The placement portion 50 includes a link coupling portion 50a to which one end portion of a link member 51 is coupled. As illustrated in FIG. 23, a compression coil spring 98 that biases the placement portion 50 in a direction in which the UV irradiator 17 is lifted is disposed between the link coupling portion 50a and a holding frame 52. An upper end portion of the compression coil spring 98 is engaged with the link coupling portion 50a in the vicinity of the coupled part between the link member 51 disposed backward and the link coupling portion 50a. The compression coil spring 98 biases the link coupling portion 50a on one side in the circumferential direction around the turning center of the link member 51 disposed backward with respect to the holding frame 52. The compression coil spring 98 functions as an assist spring.

The support frame 90 is fixed to a front end portion of the lower frame 41. The guide frame 53 is disposed on the right side of the link coupling portion 50a, and the support frame 90 is disposed on the left side of the link coupling portion 50a. A guide hole 90a corresponding to the guide hole 53a of the guide frame 53 is formed in the support frame 90. Also, a vertically long through-hole 90b that penetrates through the support frame 90 in the left-right direction is formed in the support frame 90. The through-hole 90b is formed in front of the guide hole 90a. Note that illustration of the through-hole 90b is omitted in FIG. 23 and illustration of the guide hole 90a is omitted in FIG. 25.

Similarly to the support frame 80, a side surface of the through-hole 90b is a stepped portion 90d with a step shape where a plurality of stepped surfaces 90c aligned in the up-down direction are formed. Steps between stepped surfaces 90c that are adjacent in the up-down direction are constant. A scale plate 97 on which a scale 96 indicating the height of the UV irradiator 17 is marked is fixed to the guide frame 53 or the support frame 90.

The turning shaft 93 is disposed such that the axis direction of the turning shaft 93 and the left-right direction coincide with each other. The eccentric cams 94 are eccentric disk cams formed into a disk shape. The eccentric cams 94 are fixed to both end portions of the turning shaft 93, and the two eccentric cams 94 are turnable together with the turning shaft 93. The centers of the eccentric cams 94 deviate from the axial center of the rotation shaft 93. The amount of eccentricity which is the distance between the centers of the eccentric cams 94 and the axial center of the turning shaft 93 is equal to half the step between the stepped surfaces 90c that are adjacent in the up-down direction.

Cam disposition holes where the eccentric cams 94 are disposed are formed at front end portions of side surface portions 50b that configure side surfaces of the link coupling portion 50a in the left-right direction. The eccentric cams 94 are turnably held by the side surface portions 50b. In other words, the turning shaft 93 to which the eccentric cams 94 are fixed is turnably held by the placement portion 50 via the eccentric cams 94. Specifically, both end portions of the turning shaft 93 are turnably held by the front end portions of the placement portion 50 via the eccentric cams 94. The turning shaft 93 and the eccentric cams 94 are turnable with respect to the placement portion 50 with the left-right direction defined as a turning axis direction.

Both ends of the turning shaft 93 project further outward in the left-right direction than the link coupling portion 50a. The right end portion of the turning shaft 93 is inserted into the guide hole 53a of the guide frame 53, and the left end portion of the turning shaft 93 is inserted into the guide hole 90a of the support frame 90. Also, the right end of the turning shaft 93 projects further rightward than the guide frame 53, and the left end of the turning shaft 93 projects further leftward than the support frame 90. A clamp lever 88 is attached to the left end portion of the turning shaft 93 that projects further leftward than the support frame 90.

The engagement member 91 is disposed between the two side surface portions 50b in the left-right direction. Also, the engagement member 91 is disposed to be adjacent to the right side of the side surface portion 50b disposed on the left side. An insertion hole into which the turning shaft 93 is inserted is formed in the engagement member 91. The engagement member 91 is turnably held by the front end portion of the link coupling portion 50a via the turning shaft 93 and the eccentric cams 94. Also, the turning shaft 93 is turnable with respect to the engagement member 91. The engagement member 91 includes a placement portion 91a placed on the stepped surfaces 90c (see FIG. 24). The placement portion 91a is disposed at a front lower end portion of the engagement member 91 and is disposed further forward and downward than the turning shaft 93. Also, the placement portion 91a is disposed at a left end portion of the engagement member 91.

One end side of the tension coil spring 92 is engaged with a rear upper end portion of the engagement member 91. The other end portion of the tension coil spring 92 is engaged with a spring engagement portion 50c disposed at a front end portion of the link coupling portion 50a. The spring engagement portion 50c is disposed behind the engagement member 91. The tension coil spring 92 biases the engagement member 91 in the clockwise direction (the clockwise direction in FIG. 25) around the turning shaft 93 at the center in a view from the right side. The placement portion 91a disposed at the front lower end portion of the engagement member 91 is disposed behind the stepped portions 90d. The tension coil spring 92 biases the engagement member 91 in the direction in which the placement portion 91a moves toward the stepped portion 90d.

The placement portion 91a is placed on the stepped surfaces 90c with the own weight of the UV irradiator 17 and the like. Furthermore, since the engagement member 91 is biased in the direction in which the placement portion 91a moves toward the stepped portion 90d, the placement portion 91a is automatically placed on the stepped surface 90c in accordance with the height of the UV irradiator 17 by lifting the UV irradiator 17 together with the placement portion 50. Once the engagement member 91 is turned against the biasing force of the tension coil spring 92 (that is, the engagement member 91 is turned in the counterclockwise direction in a view from the right side such that the placement portion 91a moves away from the stepped portion 90d), the placement portion 91a is detached from the stepped surface 90c, and the UV irradiator 17 can be lowered together with the placement portion 50. Note that a finger hooking portion 91b to turn the engagement member 91 against the biasing force of the tension coil spring 92 is formed at the front upper end portion of the engagement member 91.

In the modification example, it is possible to lift and lower the UV irradiator 17 together with the placement portion 50 if the eccentric cam 88a of the clamp lever 88 is disposed at the position indicated by the two-dotted dashed line in FIG. 24. On the other hand, if the clamp lever 88 is turned with the front-rear direction defined as a turning axis direction such that the eccentric cam 88a is disposed at the position indicated by the solid line in FIG. 24, a state where the front end portion of the link coupling portion 50a is fixed to the guide frame 53 and the support frame 90 is achieved, and a state where it is not possible to lift and lower the UV irradiator 17 together with the placement portion 50 is achieved.

Note that the turning shaft 93 is inserted into a washer 89 and the washer 89 is fixed to the turning shaft 93 on the right side of the guide frame 53. Also, the turning shaft 93 is inserted into a washer 89 and the washer 89 is movable in the left-right direction with respect to the turning shaft 93 on the left side of the support frame 90 and on the right side of the clamp lever 88. Therefore, if the clamp lever 88 is turned such that the eccentric cam 88a is disposed at the position indicated by the solid line in FIG. 24, a state where the guide frame 53, the support frame 90, and the link coupling portion 50a are sandwiched between the two washers 89 and the front end portion of the link coupling portion 50a is fixed to the guide frame 53 and the support frame 90 is achieved.

In the modification example, the eccentric cam 88a of the clamp lever 88 is caused to move to the position indicated by the two-dotted dashed line in FIG. 24 to adjust the height (the position in the up-down direction) of the UV irradiator 17. When the height of the UV irradiator 17 is adjusted, the operator of the printing apparatus 1 first manually lifts the link coupling portion 50a. Once the link coupling portion 50a is lifted, the placement portion 91a is automatically placed on the stepped surface 90c in accordance with the height of the link coupling portion 50a.

Thereafter, the operator turns the clamp lever 88 and thereby turns the eccentric cam 94 with the left-right direction defined as the turning axis direction. Since the eccentric cam 94 is turned with respect to the link coupling portion 50a and the engagement member 91 with the turning shaft 93 defined as a turning center, the link coupling portion 50a moves upward and downward with respect to the engagement member 91 if the eccentric cam 94 is turned. Since the link coupling portion 50a moves upward and downward with respect to the engagement member 91 if the eccentric cam 94 is turned in this manner, it is possible to finely adjust the height of the UV irradiator 17 using the eccentric cam 94 in the modification example.

Note that the link coupling portion 50a may be caused to move upward and downward using a screw member. In this case, the operator may manually rotate the screw member, or the UV irradiation device 4 may include a motor to cause the screw member to rotate.

### Modification Example of Cover and Modification Example of Peripheral Portion of Cover

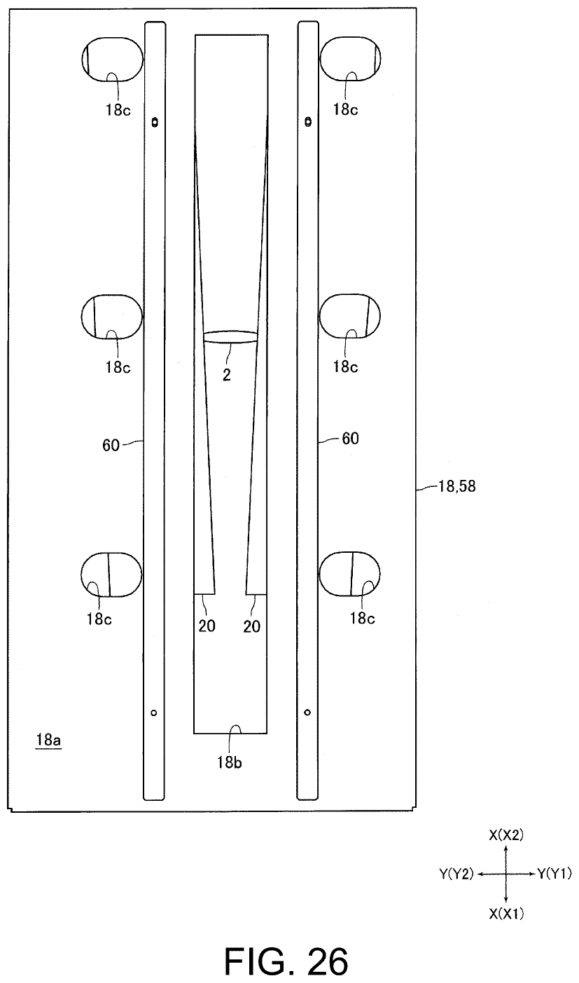

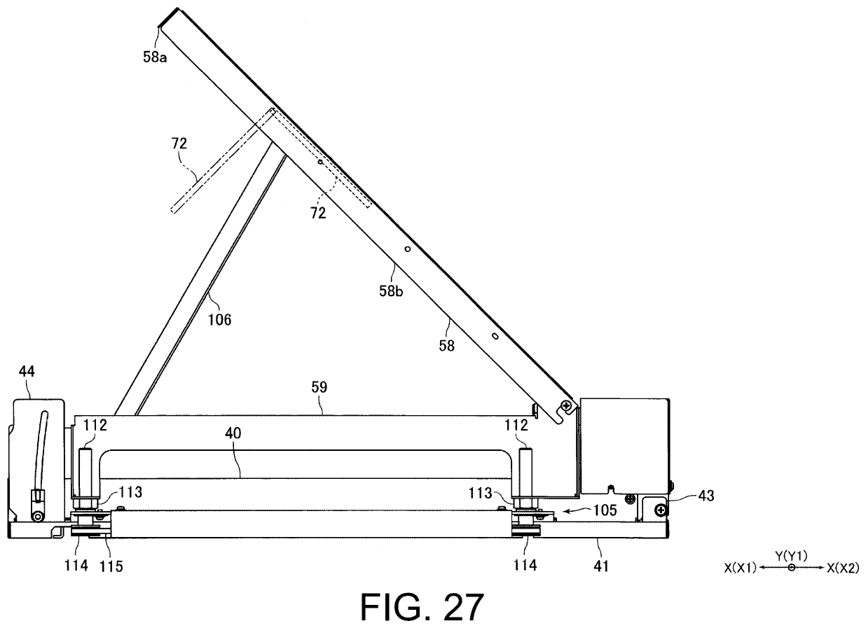

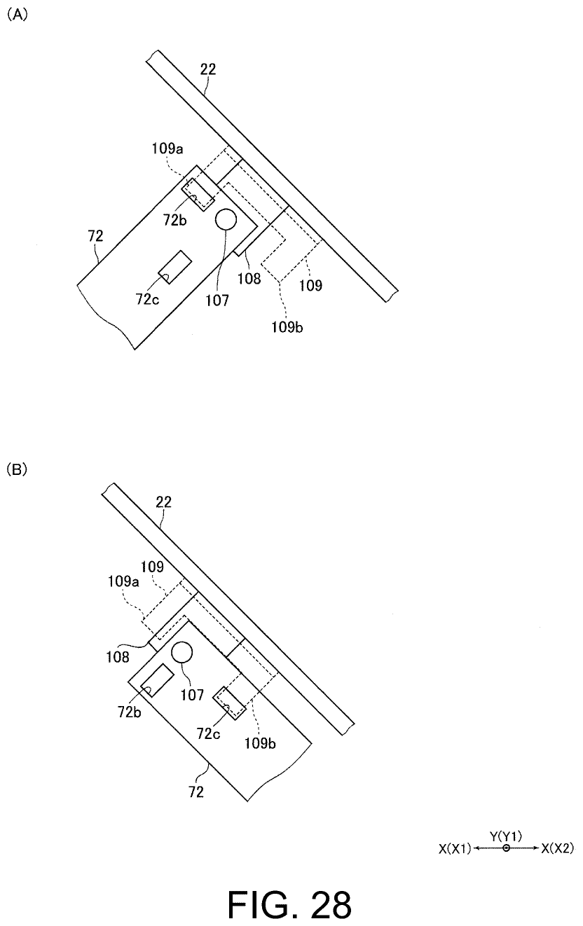

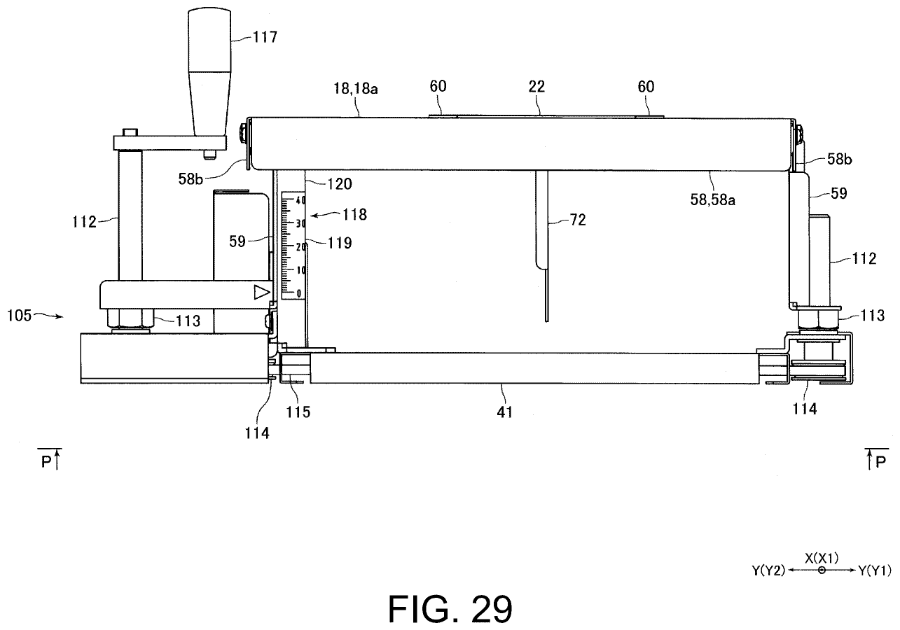

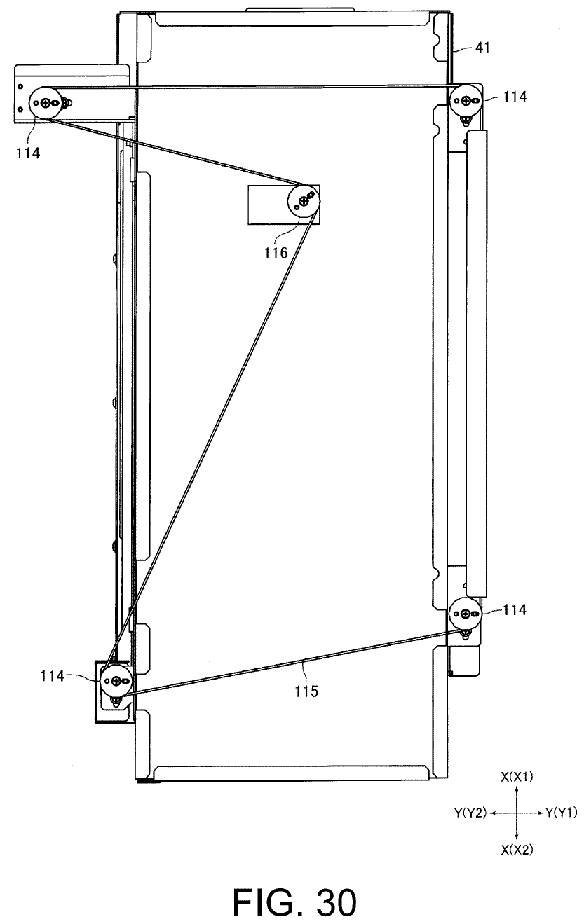

FIG. 26 is a plan view for explaining a configuration of a cover portion 18a according to another embodiment of the present invention. FIG. 27 is a side view for explaining a configuration of a cover 18 according to another embodiment of the present invention. FIG. 28 are enlarged side views for explaining a configuration of a third cover 22 according to another embodiment of the present invention. FIG. 29 is a front view for explaining a configuration of a UV irradiation device 4 according to another embodiment of the present invention. FIG. 30 is a bottom view illustrating a configuration of a part of the UV irradiation device 4 from a P-P direction in FIG. 29. Note that the same configurations as those in the aforementioned embodiment are denoted by the same reference signs in FIGS. 26 to 30.

Although the UV irradiation device 4 includes the cover position adjustment mechanism 21 in the aforementioned embodiment, the UV irradiation device 4 does not include the cover position adjustment mechanism 21 in this modification example. In the modification example, a plurality of through-holes 18c to allow the operator to directly touch upper surfaces of second covers 20 to adjust the positions of the second covers 20 in the left-right direction and the inclination thereof are formed in the cover portion 18a (see FIG. 26). The through-holes 18c are formed on both sides of an opening 18b in the left-right direction. Also, the through-holes 18c are formed at three locations, for example, on each of both sides of the opening 18b in the left-right direction.

Also, although the cover upper portion 58 is detached from the cover lower portions 59 when the print object 2 is replaced in the aforementioned embodiment, a cover upper portion 58 can be turned with respect to cover lower portions 59 such that the cover upper portion 58 is opened with respect to the cover lower portions 59 up to a position where the print object 2 can be replaced when the print object 2 is replaced in the modification example (see FIG. 27). Furthermore, in the modification example, it is possible to fold the detected member 72 attached to the third cover 22 when the cover upper portion 58 is opened in a state where the third cover 22 is placed on the cover portion 18a (see the broken line and the two-dotted dashed line in FIG. 27). Furthermore, the UV irradiation device 4 includes a cover lifting and lowering mechanism 105 that lifts and lowers the cover lower portions 59 with respect to the lower frame 41 in the modification example (see FIG. 29).

In the modification example, a rear end portion of the cover upper portion 58 is turnably coupled to rear upper end portions of the cover lower portions 59 as illustrated in FIG. 27. The cover upper portion 58 is turnable with respect to the cover lower portions 59 with the left-right direction defined as a turning axis direction. In the modification example, the operator turns the cover upper portion 58 with respect to the cover lower portions 59 up to the position where the print object 2 can be replaced and opens the cover upper portion 58 when the print object 2 is replaced. A support member 106 for supporting the cover upper portion 58 in the opened state from the lower side is attached to the cover lower portions 59. One end portion of the support member 106 is turnably attached to front upper end portions of the cover lower portions 59. The other end portion of the support member 106 can be engaged with the cover upper portion 58 from the lower side. The support member 106 can be accommodated inside the cover lower portions 59.

In the modification example, the detected member 72 is turnable with respect to the third cover 22 with the left-right direction defined as a turning axis direction. As illustrated in FIG. 28, the detected member 72 is turnable with respect to the third cover 22 with the turning center shaft 107, which is disposed below the third cover 22, defined as a turning center. A shaft holding member 108 to which the turning center shaft 107 is attached is fixed to a lower surface of the third cover 22. The detected member 72 is turnable with respect to the third cover 22 between a detectable position (the position indicated by the two-dotted dashed line in FIG. 27) where the detected member 72 extends downward from the cover upper portion 58 and an accommodation position (the position indicated by the broken line in FIG. 27) where the detected member 72 is accommodated inside the cover upper portion 58.

A plate spring 109 to hold the detected member 72 is fixed to the lower surface of the third cover 22. The plate spring 109 includes a first engagement portion 109a to hold the detected member 72 at the detectable position and a second engagement portion 109b to hold the detected member 72 at the accommodation position. A first engagement hole 72b with which the first engagement portion 109a is engaged and a second engagement hole 72c with which the second engagement portion 109b is engaged are formed in the detected member 72. During printing on the print object 2, the detected member 72 is disposed at the detectable position (see (A) of FIG. 28). Also, when the cover upper portion 58 is opened to replace the print object 2, the operator turns the detected member 72 from the detectable position to the accommodation position such that the detected member 72 does not disturb the work of replacing the print object 2 (see (B) of FIG. 28).

The cover lifting and lowering mechanism 105 includes screw members 112 held by the lower frame 41 such that rotation with the up-down direction defined as a rotation axis direction is enabled and nut members 113 screwed into the screw member 112 and fixed to the cover lower portions 59. The screw members 112 and the nut members 113 are disposed in the vicinity of four corners of the UV irradiation device 4. In other words, the cover lifting and lowering mechanism 105 includes the four screw members 112 and the four nut members 113. The nut members 113 are fixed to lower ends of the cover lower portions 59.

Pulleys 114 are fixed to lower end portions of the screw members 112. As illustrated in FIG. 30, a belt 115 is stretched over the four pulleys 114. Also, the cover lifting and lowering mechanism 105 includes an idle pulley 116 to adjust a tension of the belt 115. A lever 117 to cause the screw member 112 to rotate is attachable to and detachable from an upper end portion of one screw member 112 from among the four screw members 112.

In the modification example, the operator attaches a lever 117 to one screw member 112 and causes the lever 117 to rotate when the heights of the cover lower portions 59 are adjusted and the height of the cover 18 is adjusted. Once the lever 117 is caused to rotate, four screw members 112 rotate together, and the cover lower portions 59 is lifted or lowered with respect to the lower frame 41. When the cover lower portions 59 are lifted and lowered, the four screw members 112 synchronously rotate, and the horizontal state of the cover portion 18a is thus maintained. Once the adjustment of the height of the cover 18 ends, the lever 117 is detached.

The UV irradiation device 4 includes a scale plate 119 on which a scale 118 indicating the height of the cover 18 is marked. The scale plate 119 is fixed to a fixation member 120 fixed to the lower frame 41. Note that the cover lifting and lowering mechanism 105 may include a motor that causes the screw members 112 to rotate.

### Modification Example of Rotation Mechanism

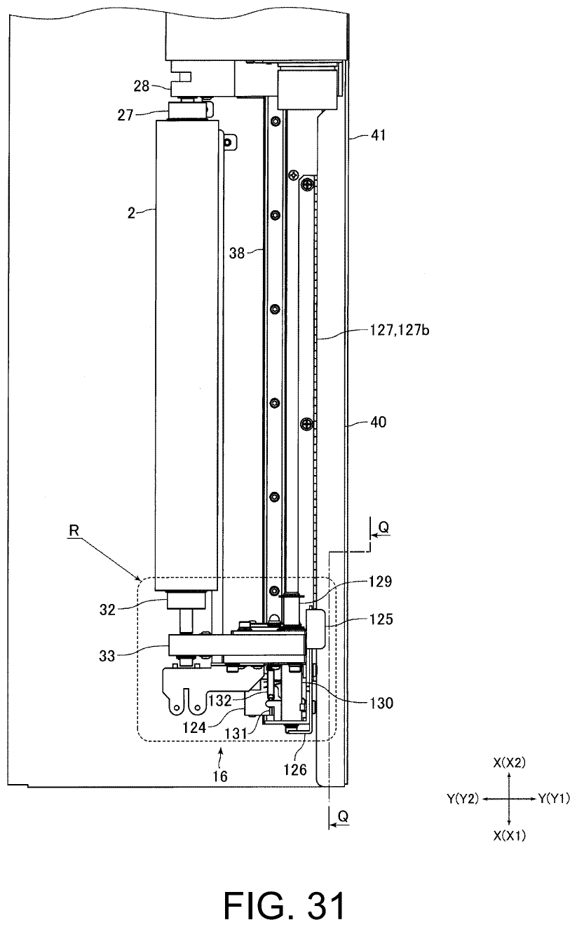

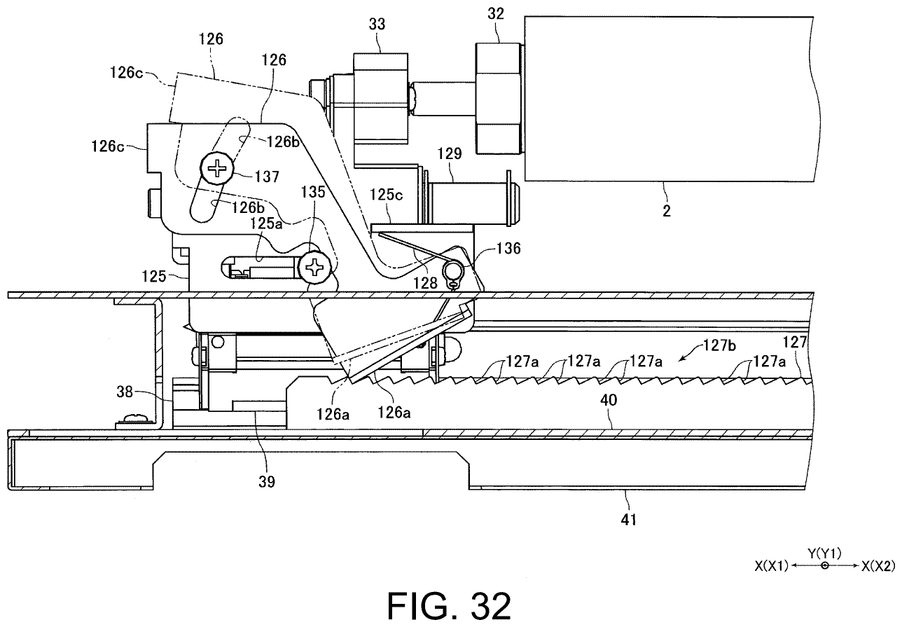

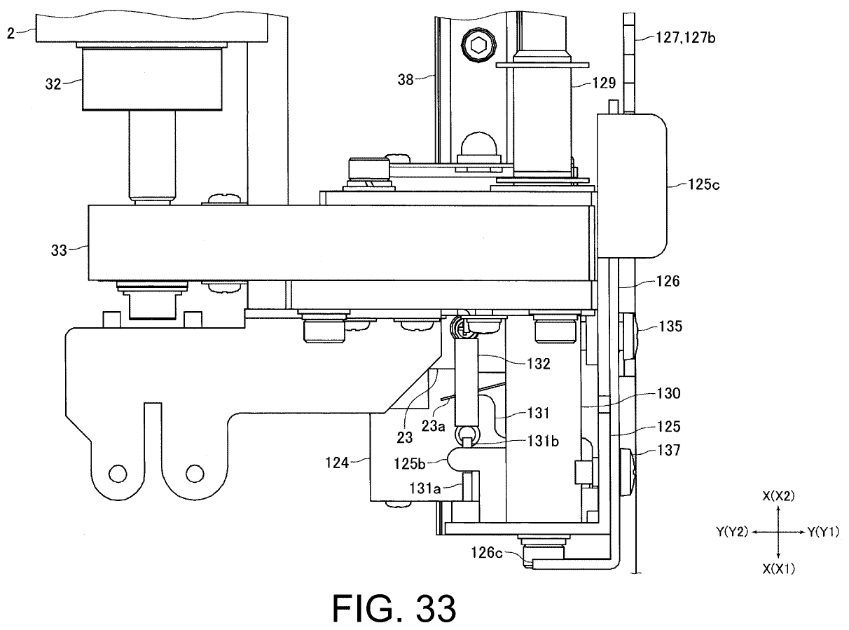

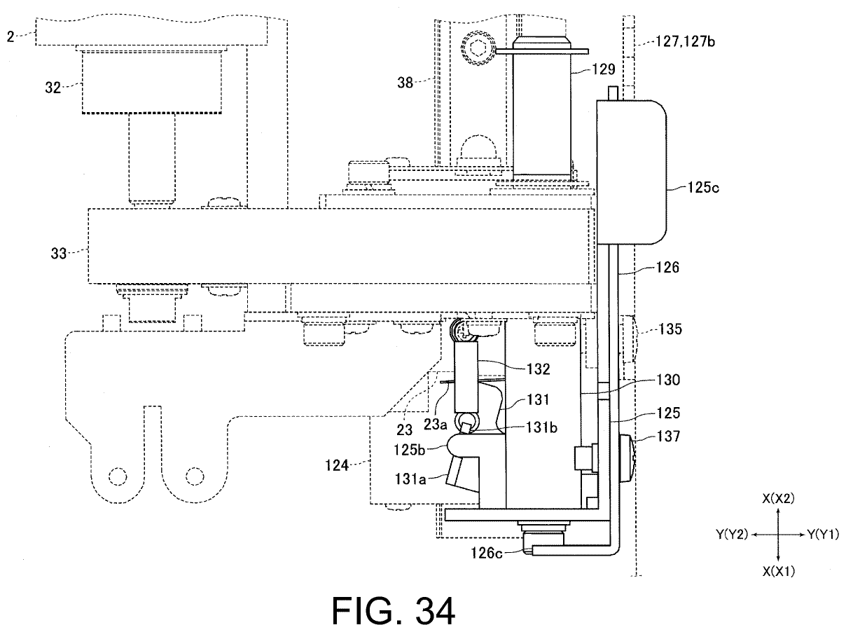

FIG. 31 is a plan view for explaining a configuration of a rotation mechanism 16 according to another embodiment of the present invention. FIG. 32 is a sectional view of a Q-Q section in FIG. 31. FIGS. 33 and 34 are enlarged plan views for explaining a configuration of a portion R in FIG. 31. Note that the same configurations as those in the aforementioned embodiment are denoted by the same reference signs in FIGS. 31 to 34.

Although the rotation mechanism 16 includes the third holding portion 34 and the compression coil spring 35 in the aforementioned embodiment, the rotation mechanism 16 in the modification example does not include the third holding portion 34 and the compression coil spring 35. In the modification example, a second holding portion 33 is fixed to a guide block 39. In the modification example, the rotation mechanism 16 includes a fixation member 124 fixed to the guide block 39, a slide member 125 held by the fixation member 124 such that movement in the front-rear direction with respect to the fixation member 124 is enabled, an engagement member 126 held by the slide member 125 such that turning with respect to the slide member 125 with the left-right direction defined as an axis direction is enabled, and a restricting member 127 for restricting forward movement of the slide member 125 and the engagement member 126.

Also, the rotation mechanism 16 includes a torsion coil spring 128 (see FIG. 32) that biases the engagement member 126 on one side in the turning direction of the engagement member 126 with respect to the slide member 125, a fixation shaft 129 that is fixed to the slide member 125, a compression coil spring 130 into which the fixation shaft 129 is inserted, a turning member 131 that is held by the fixation member 124 such that turning with respect to the fixation member 124 with the up-down direction defined as a turning axis direction is enabled, and a tension coil spring 132 that biases the turning member 131 on one side in the turning direction of the turning member 131 with respect to the fixation member 124.

A guide hole 125a to guide the slide member 125 in the front-rear direction with respect to the fixation member 124 and restrict a movement range of the slide member 125 in the front-rear direction with respect to the fixation member 124 is formed in the slide member 125 (see FIG. 32). The guide hole 125a is an elongated hole that is long in the front-rear direction. A guide screw 135 fixed to the fixation member 124 is inserted into the guide hole 125a. The slide member 125 includes a turning restricting portion 125b that restricts turning of the turning member 131 on one side in the turning direction of the turning member 131 with respect to the fixation member 124 and a spring engagement portion 125c with which one end portion of the torsion coil spring 128 comes into contact.

The fixation shaft 129 is disposed such that the axis direction of the fixation shaft 129 and the front-rear direction coincide with each other. A front end of the fixation shaft 129 is fixed to the slide member 125. A through-hole into which the fixation shaft 129 is inserted is formed in the second holding portion 33. As described above, the fixation shaft 129 is inserted on an inner peripheral side of the compression coil spring 130. A front end of the compression coil spring 130 is in contact with the slide member 125. A rear end of the compression coil spring 130 is in contact with the second holding portion 33. The compression coil spring 130 biases the second holding portion 33 backward with respect to the slide member 125. In other words, the compression coil spring 130 biases the second rotating portion 32, the second holding portion 33, the guide block 39, and the fixation member 124 backward with respect to the slide member 125.

The restricting member 127 is formed into an elongated shape that is thin and long in the front-rear direction. The restricting member 127 is fixed to the turning frame 40. The restricting member 127 includes a sawtooth-shaped restricting portion 127b where a plurality of restricting surfaces 127a aligned in the front-rear direction are formed (see FIG. 32). The restricting portion 127b is formed on an upper end surface of the restricting member 127. The restricting surfaces 127a are inclined surfaces that are inclined such that the inclined surfaces are located further upward toward the front side. Pitches of the plurality of restricting surfaces 127a (pitches in the front-rear direction) are constant.

The engagement member 126 is turnable with respect to the slide member 125 with a turning center shaft 136 (see FIG. 32), which is fixed to a rear end portion of the slide member 125, located at the turning center. The turning center shaft 136 is disposed such that the axis direction of the turning center shaft 136 and the left-right direction coincide with each other. The turning center shaft 136 is disposed below the spring engagement portion 125c. An insertion hole into which the turning center shaft 136 is inserted is formed at a rear end portion of the engagement member 126. The engagement member 126 includes an engagement portion 126a which is engaged with the restricting surfaces 127a (see FIG. 32). The engagement portion 126a is disposed at a lower end portion of the engagement member 126. When the print object 2 is accurately attached to the rotation mechanism 16, the front end surface of the engagement portion 126a is in contact with the restricting surfaces 127a with a predetermined contact pressure.

A guide hole 126b to guide the engagement member 126 in the turning direction of the engagement member 126 with respect to the slide member 125 and restrict the turning range of the engagement member 126 with respect to the slide member 125 is formed in the engagement member 126 (see FIG. 32). The guide hole 126b is disposed on the side further forward than the turning center shaft 136. Also, the guide hole 126b is disposed on the side further upward than the turning center shaft 136. The guide hole 126b in a view from the left-right direction is formed to have an arc shape with the axial center of the turning center shaft 136 located at a curvature center. A guide screw 137 fixed to the slide member 125 is inserted into the guide hole 126b.

The turning center shaft 136 is inserted into the torsion coil spring 128. One end portion of the torsion coil spring 128 is in contact with the spring engagement portion 125c of the slide member 125. The other end portion of the torsion coil spring 128 is in contact with the engagement member 126. The torsion coil spring 128 biases the engagement member 126 in the counterclockwise direction (the counterclockwise direction in FIG. 32) around the turning center shaft 136 at the center in a view from the right side. The engagement portion 126a disposed at a lower end portion of the engagement member 126 is disposed above the restricting portion 127b. The torsion coil spring 128 biases the engagement member 126 in a direction in which the engagement portion 126a moves toward the restricting portion 127b.

Once the engagement member 126 is turned against the biasing force of the torsion coil spring 128 (that is, once the engagement member 126 is turned in the clockwise direction in a view from the right side such that the engagement portion 126a moves away from the restricting portion 127b), the engagement portion 126a is detached from the restricting surfaces 127a as illustrated by the two-dotted dashed line in FIG. 32. Therefore, once the engagement member 126 is turned against the biasing force of the torsion coil spring 128, it is possible to cause the slide member 125 and the engagement member 126 to move forward. Note that a finger hooking portion 126c to turn the engagement member 126 against the biasing force of the torsion coil spring 128 is formed at a front upper end portion of the engagement member 126.

In the modification example, when the print object 2 is accurately attached to the rotation mechanism 16, forward movement of the slide member 125 and the engagement member 126 is restricted by the restricting surfaces 127a and the engagement portion 126a in contact with the restricting surfaces 127a. Also, when the print object 2 is accurately attached to the rotation mechanism 16, the compression coil spring 130 has contracted by a predetermined amount (contracted by about 5 (mm), for example), and the second rotating portion 32, the second holding portion 33, the guide block 39, and the fixation member 124 are being biased backward with respect to the slide member 125 with the biasing force of the compression coil spring 130. Therefore, when the print object 2 is accurately attached to the rotation mechanism 16, the front end surface of the print object 2 is in contact with the second rotating portion 32 with a predetermined contact pressure, and the rear end surface of the print object 2 is in contact with the first rotating portion 27 with a predetermined contact pressure.

The turning member 131 is turnable with respect to the fixation member 124 with the turning center shaft, which is fixed to a front end portion of the fixation member 124, defined as a turning center. The turning center shaft is disposed such that the axis direction of the turning center shaft and the up-down direction coincide with each other. The turning member 131 includes a restricted portion 131a disposed in front of the turning restricting portion 125b and a spring engagement portion 131b with which a front end portion of the tension coil spring 132 is engaged. The restricted portion 131a is disposed at a left front end portion of the turning member 131. The spring engagement portion 131b is disposed behind the restricted portion 131a.

A first detection mechanism 23 is disposed behind the turning member 131. The first detection mechanism 23 is attached to the fixation member 124 such that a lever 23a is disposed in front of a main body portion of the first detection mechanism 23. A rear end portion of the turning member 131 can come into contact with the lever 23a from the front side. A rear end portion of the tension coil spring 132 is engaged with the second holding portion 33. A front end portion of the tension coil spring 132 is engaged with the spring engagement portion 131b of the turning member 131 as described above. The tension coil spring 132 biases the turning member 131 in the clockwise direction (the clockwise direction in FIGS. 33 and 34) with the turning center of the turning member 131 located at the center in a view from the upper side. The turning of the turning member 131 in the clockwise direction in FIGS. 33 and 34 is restricted by the turning restricting portion 125b disposed behind the restricted portion 131a.

In the modification example, when the print object 2 is attached to the rotation mechanism 16, the print object 2 is disposed between a first rotating portion 27 and a second rotating portion 32, and the slide member 125 and the engagement member 126 are then caused to move backward until the compression coil spring 130 contracts by a predetermined amount. Once the slide member 125 and the engagement member 126 move backward, the second rotating portion 32, the second holding portion 33, the guide block 39, and the fixation member 124 are also pressed by the compression coil spring 130 and move backward. Once the slide member 125 and the engagement member 126 are caused to move backward until the compression coil spring 130 contracts by the predetermined amount, the front end surface of the print object 2 comes into contact with the second rotating portion 32 with a predetermined contact pressure, the rear end surface of the print object 2 comes into contact with the first rotating portion 27 with a predetermined contact pressure, and the print object 2 is accurately set in the rotation mechanism 16.

When the print object 2 is accurately attached to the rotation mechanism 16, the compression coil spring 130 has contracted by a predetermined amount, the slide member 125 has moved relatively backward with respect to the second holding portion 33, and the turning restricting portion 125b has moved backward. At this time, the turning member 131 has turned in the clockwise direction in FIG. 34, and the rear end portion of the turning member 131 has pressed the lever 23a backward as illustrated in FIG. 34. Specifically, the rear end portion of the turning member 131 presses the lever 23a backward up to the position where the lever 23a presses the contact member of the first detection mechanism 23. Therefore, the fact that the print object 2 has been accurately attached to the rotation mechanism 16 is detected by the first detection mechanism 23.

When the print object 2 is detached from the rotation mechanism 16, the engagement member 126 is turned against the biasing force of the torsion coil spring 128, and the slide member 125 and the engagement member 126 are caused to move forward up to a position where the print object 2 can be detached from between the first rotating portion 27 and the second rotating portion 32.

### Other Embodiments

Although the aforementioned embodiments are exemplary preferred embodiments of the present invention, the present invention is not limited thereto, and various modifications can be made without changing the gist of the present invention.

In the aforementioned embodiments, the adjustment value calculation unit 78 may calculate the height of the cover 18 after the adjustment on the basis of the information regarding the outer shape of the print object 2 input to the input unit 75. In this case, the display 76 displays the height of the cover 18 after the adjustment calculated by the adjustment value calculation unit 78. Also, in the aforementioned embodiments, the adjustment value calculation unit 78 may not calculate the angle of the rotation mechanism 16 after the adjustment or the height of the UV irradiator 17 after the adjustment. In the aforementioned embodiments, the UV irradiation device 4 may not include the adjustment value calculation unit 78.

Although the cover upper portion 58 and the cover lower portions 59 are formed as separate bodies and the cover upper portion 58 and the cover lower portions 59 can be separated in the aforementioned embodiments, the cover upper portion 58 and the cover lower portions 59 may be integrally formed. In the aforementioned embodiments, the second covers 20 may be disposed above the cover 18.

In the aforementioned embodiments, the position of the cover 18 in the up-down direction may not be adjustable in a case where the printing apparatus 1 performs printing only on the print object 2 with a specific outer diameter. Also, in the case where the printing apparatus 1 performs printing only on the print object 2 with a specific outer diameter, the UV irradiation device 4 may not include the second covers 20 and the cover position adjustment mechanism 21. Also, in the case where the printing apparatus 1 performs printing only on the print object 2 with a specific outer diameter, the position of the UV irradiator 17 in the up-down direction may not be adjustable.

In a case where the printing apparatus 1 performs printing only on the print object 2 with a specific length in the aforementioned embodiments, the UV irradiation device 4 may not include the third cover 22. Also, in a case where the printing apparatus 1 performs printing only on the print object 2 with a cylindrical outer shape in the aforementioned embodiments, the inclination of the rotation mechanism 16 with respect to the horizontal direction in a view from the left-right direction may not be adjustable. Also, in the case where the printing apparatus 1 performs printing only on the print object 2 with a cylindrical outer shape, the inclination of the UV irradiator 17 with respect to the axial center of the print object 2 in a view from the up-down direction may not be adjustable.

In the aforementioned embodiments, the UV irradiation device 4 may be placed on the table 5 such that the front-rear direction (X direction) and the main scanning direction coincide with each other (that is, such that the left-right direction and the sub-scanning direction coincide with each other). Also, in the aforementioned embodiments, the printing apparatus 1 may include a Y bar driving mechanism that causes a Y bar 8 to move in the sub-scanning direction instead of the stage driving mechanism 12. In the aforementioned embodiments, the UV irradiator 17 may be disposed below the print object 2.

### REFERENCE SIGNS LIST

1 Printing apparatus
2 Print object
3 Inkjet head
4 UV irradiation device
5 Table
16 Rotation mechanism
17 UV irradiator
18 Cover
18a Cover portion
18b Opening
20 Second cover
75 Input unit
76 Display (display unit)
77 ENTER key (input key)
78 Adjustment value calculation unit
Y Left-right direction

1. A UV irradiation device that is used in a printing apparatus for performing a printing using a UV curable ink on an outer peripheral surface of a print object with a cylindrical, frustoconical, or conical outer shape, the UV irradiation device comprising:
a rotation mechanism, holding the print object and configured to cause the print object to rotate about an axial center of the print object as a rotation center;
a UV irradiator, configured to irradiate the outer peripheral surface of the print object with the ink adhering thereto with UV rays;
an input unit, used by an operator of the UV irradiation device to input an information regarding an outer shape of the print object; and
a display unit, configured to display mechanical adjustment items of the UV irradiation device,
wherein
once the information regarding the outer shape of the print object is input to the input unit, the display unit is able to display the adjustment items.

2. The UV irradiation device as set forth in claim 1, further comprising:
an input key, used by the operator to input a fact that an adjustment of one of the adjustment items has been ended,
wherein
the number of the adjustment items is more than one, and
once the adjustment of the one of the adjustment items is ended and the input key is pressed, the display unit displays a next adjustment item.

3. The UV irradiation device as set forth in claim 1, further comprising:
a cover, including:
a cover portion, including an opening formed therein and covering the UV irradiator from an upper side, and an upper end portion of the print object being disposed in the opening; and
two second covers, for blocking a part of the opening,
wherein
the ink ejected from above the print object lands on the outer peripheral surface of the print object,
the UV irradiator is disposed on a lateral side of the print object and irradiates the outer peripheral surface of the print object with UV rays from the lateral side of the print object,
an outer shape of the print object is a frustoconical or conical shape,
when a direction perpendicularly intersecting the axial center of the print object in a view from an up-down direction is defined as a left-right direction,
the second cover, which is one of the two second covers, is able to block a part of the opening from one side in the left-right direction, while the other second cover is able to block a part of the opening from the other side in the left-right direction,
an angle of the rotation mechanism with respect to a horizontal direction in a view from the left-right direction, a height of the UV irradiator, a position of the UV irradiator in the left-right direction, an angle of the UV irradiator with respect to the axial center of the print object in a view from the up-down direction, a height of the cover, a position of each of the two second covers in the left-right direction, and angles of the second covers with respect to the axial center of the print object in a view from the up-down direction are able to be adjusted, and
the adjustment items include: adjustment of the angle of the rotation mechanism with respect to the horizontal direction in a view from the left-right direction, adjustment of the height of the UV irradiator, adjustment of the position of the UV irradiator in the left-right direction and the angle of the UV irradiator with respect to the axial center of the print object in a view from the up-down direction, adjustment of the height of the cover, and adjustment of the positions of the two second covers in the left-right direction and the angles of the second covers with respect to the axial center of the print object in a view from the up-down direction.

4. The UV irradiation device as set forth in claim 1, further comprising:
an adjustment value calculation unit, configured to calculate a predetermined adjustment value of the UV irradiation device on the basis of the information regarding the outer shape of the print object input to the input unit,
wherein
the ink ejected from above the print object lands on the outer peripheral surface of the print object,
an outer shape of the print object is a frustoconical or conical shape,
when a direction perpendicularly intersecting an axial center of the print object in a view from an up-down direction is defined as a left-right direction,
an angle of the rotation mechanism with respect to a horizontal direction in a view from the left-right direction is able to be adjusted, and the adjustment items include adjustment of the angle of the rotation mechanism with respect to the horizontal direction in a view from the left-right direction,
the adjustment value calculation unit calculates an angle of the rotation mechanism after the adjustment with respect to the horizontal direction in a view from the left-right direction on the basis of the information regarding the outer shape of the print object input to the input unit, and
the display unit displays the angle of the rotation mechanism after the adjustment calculated by the adjustment value calculation unit.

5. The UV irradiation device as set forth in claim 1, further comprising:
an adjustment value calculation unit, configured to calculate a predetermined adjustment value of the UV irradiation device on the basis of the information regarding the outer shape of the print object input to the input unit,
wherein
the ink ejected from above the print object lands on the outer peripheral surface of the print object,
the UV irradiator is disposed on a lateral side of the print object and irradiates the outer peripheral surface of the print object with UV rays from the lateral side of the print object,
a height of the UV irradiator is adjustable, and the adjustment items include adjustment of a height of the UV irradiator,
the adjustment value calculation unit calculates the height of the UV irradiator after the adjustment on the basis of the information regarding the outer shape of the print object input to the input unit, and
the display unit displays the height of the UV irradiator after the adjustment calculated by the adjustment value calculation unit.

6. A printing apparatus comprising:
the UV irradiation device as set forth in claim 1;
a table on which the UV irradiation device is placed; and
an inkjet head disposed above the print object and configured to eject the ink toward the outer peripheral surface of the print object.

7. A method for adjusting the UV irradiation device as set forth in claim 2, comprising:
by the operator:
adjusting the adjustment item displayed on the display unit;
then, pressing the input key; and
then, adjusting the next adjustment item displayed on the display unit.

8. The UV irradiation device as set forth in claim 2, further comprising:
an adjustment value calculation unit, configured to calculate a predetermined adjustment value of the UV irradiation device on the basis of the information regarding the outer shape of the print object input to the input unit,
wherein
the ink ejected from above the print object lands on the outer peripheral surface of the print object,
an outer shape of the print object is a frustoconical or conical shape,
when a direction perpendicularly intersecting an axial center of the print object in a view from an up-down direction is defined as a left-right direction,
an angle of the rotation mechanism with respect to a horizontal direction in a view from the left-right direction is able to be adjusted, and the adjustment items include adjustment of the angle of the rotation mechanism with respect to the horizontal direction in a view from the left-right direction,
the adjustment value calculation unit calculates an angle of the rotation mechanism after the adjustment with respect to the horizontal direction in a view from the left-right direction on the basis of the information regarding the outer shape of the print object input to the input unit, and
the display unit displays the angle of the rotation mechanism after the adjustment calculated by the adjustment value calculation unit.

9. The UV irradiation device as set forth in claim 3, further comprising:
an adjustment value calculation unit, configured to calculate a predetermined adjustment value of the UV irradiation device on the basis of the information regarding the outer shape of the print object input to the input unit,
wherein
the ink ejected from above the print object lands on the outer peripheral surface of the print object,
an outer shape of the print object is a frustoconical or conical shape,
when a direction perpendicularly intersecting an axial center of the print object in a view from an up-down direction is defined as a left-right direction,
an angle of the rotation mechanism with respect to a horizontal direction in a view from the left-right direction is able to be adjusted, and the adjustment items include adjustment of the angle of the rotation mechanism with respect to the horizontal direction in a view from the left-right direction,
the adjustment value calculation unit calculates an angle of the rotation mechanism after the adjustment with respect to the horizontal direction in a view from the left-right direction on the basis of the information regarding the outer shape of the print object input to the input unit, and
the display unit displays the angle of the rotation mechanism after the adjustment calculated by the adjustment value calculation unit.

10. The UV irradiation device as set forth in claim 2, further comprising:
an adjustment value calculation unit, configured to calculate a predetermined adjustment value of the UV irradiation device on the basis of the information regarding the outer shape of the print object input to the input unit,
wherein
the ink ejected from above the print object lands on the outer peripheral surface of the print object,
the UV irradiator is disposed on a lateral side of the print object and irradiates the outer peripheral surface of the print object with UV rays from the lateral side of the print object,
a height of the UV irradiator is adjustable, and the adjustment items include adjustment of a height of the UV irradiator,
the adjustment value calculation unit calculates the height of the UV irradiator after the adjustment on the basis of the information regarding the outer shape of the print object input to the input unit, and
the display unit displays the height of the UV irradiator after the adjustment calculated by the adjustment value calculation unit.

11. The UV irradiation device as set forth in claim 3, further comprising:
an adjustment value calculation unit, configured to calculate a predetermined adjustment value of the UV irradiation device on the basis of the information regarding the outer shape of the print object input to the input unit,
wherein
the ink ejected from above the print object lands on the outer peripheral surface of the print object,
the UV irradiator is disposed on a lateral side of the print object and irradiates the outer peripheral surface of the print object with UV rays from the lateral side of the print object,
a height of the UV irradiator is adjustable, and the adjustment items include adjustment of a height of the UV irradiator,
the adjustment value calculation unit calculates the height of the UV irradiator after the adjustment on the basis of the information regarding the outer shape of the print object input to the input unit, and
the display unit displays the height of the UV irradiator after the adjustment calculated by the adjustment value calculation unit.

12. A printing apparatus comprising:
the UV irradiation device as set forth in claim 2;
a table on which the UV irradiation device is placed; and
an inkjet head disposed above the print object and configured to eject the ink toward the outer peripheral surface of the print object.

13. A printing apparatus comprising:
the UV irradiation device as set forth in claim 3;
a table on which the UV irradiation device is placed; and
an inkjet head disposed above the print object and configured to eject the ink toward the outer peripheral surface of the print object.
